(19) United States
(12) Patent Application Publication
(10) Pub. No.: US 2026/0232026 A1
(43) Pub. Date: Aug. 13, 2026

(54) A SUSCEPTOR ASSEMBLY FOR AN AEROSOL-GENERATING SYSTEM

(71) Applicant: Philip Morris Products S.A., Neuchatel (CH)

(72) Inventors: Onur DAYIOGLU, Neuchâtel (CH); Emeric Romain GRANDJEAN, Lausanne (CH); Farhang MOHSENI, Neuchâtel (CH); Patrick Charles SILVESTRINI, Neuchâtel (CH); Jean-Marc WIDMER, Lignières (CH)

(73) Assignee: Philip Morris Products S.A., Neuchatel (CH)

(21) Appl. No.: 19/155,846

(22) PCT Filed: Feb. 16, 2024
(86) PCT No.: PCT/EP2024/054018

§ 371 Date: Aug. 12, 2025

(30) Foreign Application Priority Data
Feb. 20, 2023 (EP) 23157590.3

(51) Int. Cl. A24F 40/465; A24F 40/10; A24F 40/42; A24F 40/44; A24F 40/485; H05B 6/10

(52) U.S. Cl. CPC A24F 40/465; A24F 40/10; A24F 40/42; A24F 40/44; A24F 40/485; H05B 6/108

(57) ABSTRACT

A heating assembly for an aerosol-generating system is provided, the assembly including a susceptor assembly including: a non-woven susceptor element as a sheet and including apertures extending from first to second surfaces of the sheet; and a wicking element coupled to the susceptor element to transport aerosol-forming liquid across a surface of the susceptor element, each aperture extending in a first direction parallel to the first and/or second surface of the susceptor element, and extending in a second direction parallel to the first and/or second surface of the susceptor element and perpendicular to the first direction, each aperture extending a greater distance in the first direction than in the second direction, the susceptor element being planar and defining a first plane, such that the first and second directions are within the first plane, the heating assembly further including an inductor that at least in part surrounds the susceptor element.

The present disclosure relates to a susceptor assembly for an aerosol-generating system; a cartridge for an aerosol-generating system; an aerosol-generating system; and an aerosol-generating device.

Aerosol-generating systems and devices configured to generate inhalable aerosol from an aerosol-forming substrate are known in the art. Some prior aerosol-generating systems comprise an aerosol-generating-device that is couplable to a cartridge. A typical cartridge for use with an aerosol-generating device comprises an aerosol-forming substrate and a heater assembly, where the heater assembly comprises a heating element. In a number of aerosol-generating systems the heating element is inductively heated, in which case the heating element is a susceptor element.

The aerosol-forming substrate may be a liquid. In this case, the cartridge or device may further comprise a wicking material in fluidic communication with the aerosol-forming substrate and in contact with the susceptor element. The wicking material is configured to transport liquid aerosol-forming substrate to the susceptor element. In use, the susceptor element is configured to vaporise the liquid aerosol-forming substrate. An airflow is provided past the susceptor element to entrain the generated vapour. In the airflow the vapour condenses, and an aerosol is formed. The aerosol may then be inhaled by a user. The aerosol-generating device typically comprises a power supply that is configured to supply power to the susceptor element by inductive heating. In an aerosol-generating system comprising a device and a cartridge, the power supply will often be configured to supply power to the susceptor element when the device and cartridge are coupled together via electrical connectors. In aerosol-generating systems of this type, the system is often configured to activate the susceptor element only when the user is puffing on the system.

Woven susceptor elements are known in the art, which generally comprise a plurality of filaments woven to create a mesh. The interstices within the mesh allow for vaporised liquid aerosol-forming substrate to pass through the susceptor element into the airflow pathway. However, there is a compromise between efficiently heating the liquid aerosol-forming substrate, by providing filaments with an optimum gauge and filament density and allowing the vaporised substrate to efficiently enter the airflow pathway, by varying the interstice size of the mesh.

It would therefore be desirable to provide a susceptor assembly for an aerosol-generating system, cartridge for an aerosol-generating system, an aerosol-generating system, and an aerosol-generating device which both efficiently heats and vaporises the liquid aerosol-forming substrate and allows the vaporised substrate to efficiently enter the airflow pathway.

According to a first embodiment of the present disclosure, there is provided a susceptor assembly for an aerosol-generating system. The susceptor assembly may comprise at least one non-woven susceptor element. The at least one non-woven susceptor element may be in the form of a sheet. The at least one non-woven susceptor element may comprise a plurality of apertures. Each aperture may extend from a first surface of the sheet to a second surface of the sheet. The susceptor assembly may comprise a wicking element coupled to the at least one non-woven susceptor element. The wicking element may be configured to transport aerosol-forming liquid across a surface of the at least one non-woven susceptor element. Each aperture of the plurality of apertures may extend in a first direction parallel to at least one of the first and second surfaces of the at least one susceptor element. Each aperture of the plurality of apertures may extend in a second direction parallel to at least one of the first and second surfaces of the at least one susceptor element and perpendicular to the first direction. Each aperture of the plurality of apertures may extend a greater distance in the first direction than in the second direction. Advantageously, it has been found that such an arrangement of elongated apertures in a first direction improves the inductive heating response of the susceptor when exposed to an alternating magnetic field in the first direction. The improved inductive heating response may then result in more preferable aerosol characteristics of the aerosol generated by the aerosol-generating system. Therefore, it is beneficial to dispose the susceptor element such that the elongated direction of the apertures is aligned with the direction of the varying magnetic field. The susceptor assembly may be configured to be heated by a magnetic field varying in a direction parallel to the first direction. The susceptor assembly may be configured to be arranged within a cartridge in an aerosol-generating system wherein the susceptor element may be heated by a magnetic field varying in a direction parallel to the first direction.

Each aperture of the plurality of apertures may extend by a first distance in the first direction. Each aperture of the plurality of apertures may extend by a second distance in the second direction. The first distance may be greater than the second distance. The first distances may not all be equal. The second distances may not all be equal. Alternatively, the first distances may be equal or substantially equal. The second distances may be equal or substantially equal.

The first distance may be between 1.5 and 10 times that of the second distance. The first distance may be between 2 and 5 times that of the second distance. The first distance may be between 2.5 and 4 times that of the second distance. The susceptor element may be planar and define a first plane, such that the first and second directions are within the first plane. The plurality of apertures may form a regular array of apertures in the at least one susceptor element. The plurality of apertures may be spaced in the first direction by a first spacing distance between 0.05 and 1 times the first distance. The plurality of apertures may be spaced in the first direction by a first spacing distance between 0.1 and 0.5 times the first distance. The plurality of apertures may be spaced in the second direction by a second spacing distance between 0.2 and 5 times the second distance. The plurality of apertures may be spaced in the second direction by a second spacing distance between 1 and 3 times the second distance.

The average first distance for all apertures of the plurality of apertures may be greater than the average second distance for all apertures of the plurality of apertures. The mean first distance for all apertures of the plurality of apertures may be greater than the mean second distance for all apertures of the plurality of apertures. The median first distance for all apertures of the plurality of apertures may be greater than the median second distance for all apertures of the plurality of apertures.

The susceptor element may comprise a regular array of apertures of the plurality of apertures The regular array of apertures may be a hexagonal array of apertures. The regular array of apertures may be a square array of apertures. Advantageously, such regular arrays may allow for ease of manufacturing of the susceptor element.

The wicking element may comprise first and second planar surfaces. The first and second surfaces may define opposite, outward-facing surfaces of the wicking element. The at least one susceptor element may comprise a first and a second planar susceptor element. The susceptor assembly may be arranged such that the first surface of the wicking element contacts the first susceptor element and the second surface of the wicking element contacts the second susceptor element. Advantageously, such an arrangement may provide efficient aerosol generation, due to the relatively large surface area provided by the two planar surfaces of the susceptor elements.

The at least one susceptor element may be folded around the wicking element, such that the first surface of the wicking element contacts a first portion of the at least one susceptor element and the second surface of the wicking element contacts a second portion of the at least one susceptor element, wherein the first portion is substantially parallel to the second portion. Advantageously, such a folded arrangement may ease manufacturing of the susceptor assembly, and increase mechanical strength of the assembly.

The at least one susceptor element may further comprise a folded portion. The folded portion may be connected between the first portion and the second portion. The folded portion may comprise an elongated aperture. The elongated aperture may extend in a direction parallel to at least one of the first and second surfaces of the wicking element. The folded portion may comprise at least one connecting portion between the first and second portions of the susceptor element. The first portion of the at least one susceptor element and the second portion of the at least one susceptor element may be integrally formed. The first portion of the at least one susceptor element and the second portion of the at least one susceptor element and the at least one connecting portion may be integrally formed. Advantageously, when the susceptor element is folded around the wicking element, the at least one connecting portion may therefore easily deform, allowing for ease of manufacturing.

Each aperture of the plurality of apertures may be circular or oval in shape. Each aperture of the plurality of apertures may be rectangular or square in shape. Advantageously, such simple shapes may ease manufacturing, particularly with regards to stamping for example. The at least one susceptor element may have a first thickness. The first thickness may be between 25 micrometres and 100 micrometres. Each aperture of the plurality of apertures may be formed via laser cutting. Each aperture of the plurality of apertures may be formed via chemical etching. Each aperture of the plurality of apertures may be formed via stamping or wire electrical discharge.

The at least one susceptor element may comprise at least one outward protrusion. The at least one outward protrusion may be on a peripheral edge of the at least one susceptor element. The at least one outward protrusion is configured to engage a susceptor holder component of a cartridge. The at least one outward protrusion may occupy a percentage of the peripheral edge of the at least one susceptor element. The proportion may be between 1% and 20% of the peripheral edge of the at least one susceptor element. The proportion may be between 2% and 10% of the peripheral edge of the at least one susceptor element. Advantageously, such outward protrusions may minimise the amount heat transferred from the susceptor element to a susceptor holder in a cartridge.

The at least one susceptor element may be heatable by at least one of Joule heating through induction of eddy currents in the susceptor element, and hysteresis losses. The at least one susceptor element may comprise at least one of graphite, molybdenum, silicon carbide, stainless steels, niobium and aluminium. The at least one susceptor element may comprise at least one ferromagnetic material. The at least one susceptor element may comprise AISI 430 stainless steel. The at least one susceptor element may have a relative permeability between 1 and 40000, when measured at frequencies up to 10 kHz at a temperature of 20 degrees Celsius. The at least one susceptor element may have a relative permeability between 500 and 40000, when measured at frequencies up to 10 kHz at a temperature of 20 degrees Celsius.

The susceptor element may be planar. The susceptor element may define a first plane. The at least one susceptor element may be substantially flat. Substantially flat may be defined as the susceptor element comprising both a width and a height much greater than a depth. The susceptor assembly may be substantially planar. The susceptor assembly may substantially define a first plane. Advantageously, such arrangements have been found to be beneficial for efficient aerosol generation, with high surface area to volume ratios.

The at least one non-woven susceptor element may comprise a first region. The first region may comprise a first configuration of apertures of the plurality of apertures. The at least one non-woven susceptor element may comprise a second region. The second region may comprise a second configuration of apertures of the plurality of apertures. The second configuration of apertures may be different from the first configuration of apertures. It has been found that varying configurations of apertures in the first and second regions varies the amount of heat generated by inductive heating of the susceptor element in those regions. Advantageously, this may be used to control how and where the heat is actually generated across susceptor element and allow for designs of susceptor elements which can be optimized to reduce the risk of overheating and of scorching of the wicking element.

The second configuration of apertures may comprise no apertures, such that the second region comprises no apertures. Advantageously, the second region may act as a heat sink or channel for transporting heat because of the absence of apertures, which may reduce the risk of overheating and of scorching of the wicking element.

The second configuration of apertures may be different from the first configuration of apertures such that a temperature of the first region increases more than a temperature of the second region when the first region is exposed to an identical alternating magnetic field as the second region, and when the alternating magnetic field is uniform across the first and second regions. The first region may comprise a first density of apertures of the plurality of apertures. A density of apertures may be defined as the number of apertures per unit area. The second region comprises a second density of apertures of the plurality of apertures. The second density of apertures is different from the first density of apertures. The second density of apertures may be less than the first density of apertures. Advantageously, it has been found that a configuration comprising apertures with higher density may generate more heat versus a configuration comprising apertures with a lower density. Adjusting the density of apertures in the first and second regions may be used to control how and where the heat is actually generated across susceptor element and allow for designs of susceptor elements which can be optimized to reduce the risk of overheating and of scorching of the wicking element. The second density of apertures may be equal to zero, such that the second region comprises no apertures.

The second region may comprise a shape comprising a central region of the susceptor element. The second region may comprise the central region of the susceptor element. The second region may surround the central region of the susceptor element. Advantageously, as wick scorch or susceptor element overheating typically occurs at a central region of the susceptor element, the susceptor element may be modified using the second region to reduce these risks.

The first region may at least partially surround the second region in the plane of the susceptor element. The first region may entirely surround the second region in the plane of the susceptor element. The first region may be located between the second region and at least one peripheral edge of the susceptor element.

The shape of the second region may further comprise a plurality of radial portions. The plurality of radial portions may extend across the susceptor element from the central region towards a periphery of the planar susceptor element. The plurality of radial portions may extend in the first plane across the susceptor element from the central region towards a periphery of the planar susceptor element. Each of the radial portions of the plurality of radial portions may be uniformly spaced from one another in the first plane about the central region. The second region may comprise between 2 and 8 radial portions. The second region may comprise between 4 and 6 radial portions.

The susceptor element may comprise two or more regions. For example, the susceptor element may comprise three or more regions. Each region of the two or more regions may comprise a configuration of apertures of the plurality of apertures. Each region of the two or more regions may comprise a configuration which is different to a configuration in at least one other region. Advantageously, the susceptor element may be designed to spatially configure the heat generated by a uniformly varying magnetic field. The susceptor element may comprise a third region. The second region may comprise a shape comprising or surrounding the third region. The third region may comprise array of third apertures identical in arrangement to the arrangement of first apertures. The apertures in the third region may be identical to each other. The apertures in the third region may be identical to the apertures may be in the first region, such that the apertures in the third region may have an identical diameter than the apertures in the first region.

Each aperture of the plurality of apertures may be equal in size. A size of each of the apertures in the first region may be different from a size of each of the apertures in the second region. The size of each of the apertures in the first region may be less than the size of each of the apertures in the second region. A first mean size of the apertures in the first region may be less than a second mean size of the apertures in the second region. The size of each of the apertures may be a cross sectional area of each of the apertures parallel to the first surface of the at least one susceptor element. Advantageously, it has been found that a configuration comprising smaller apertures with higher density may generate more heat versus a configuration comprising larger apertures with a lower density. Adjusting the size of apertures in the first and second regions may be used to control how and where the heat is actually generated across susceptor element, and allow for designs of susceptor elements which can be optimized to reduce the risk of overheating and of scorching of the wicking element.

The first region may comprise a first regular array of apertures of the plurality of apertures. The first regular array of apertures may be a hexagonal array of apertures. The first regular array of apertures may be a square array of apertures. The second region may comprise a second regular array of apertures of the plurality of apertures. The second regular array of apertures may be a hexagonal array of apertures. The second regular array of apertures may be a square array of apertures. Advantageously, such regular arrays may allow for ease of manufacturing of both the first and second regions. Each aperture of the plurality of apertures may be circular or oval in shape. Each aperture of the plurality of apertures may be rectangular or square in shape. Advantageously, such simple shapes may ease manufacturing, particularly with regards to stamping for example

The at least one non-woven susceptor element may further comprise a plurality of channels. Each channel of the plurality of channels may extend between at least two apertures of the plurality of apertures. Advantageously, the channels may contribute to liquid aerosol-forming substrate transportation across the susceptor element, increasing liquid supplied, in particular, to the centre of the susceptor element. Liquid aerosol-forming substrate transported from the wicking element towards for example a first susceptor element may reach a first aperture and then may travels along a channel to reach a proximate aperture. This transportation may therefore minimise the number of apertures to which insufficient liquid is supplied during heating of the susceptor element, which may contribute to minimising overheating of the susceptor element, and hence scorching of the wicking element. The channels may further generate a liquid meniscus of the liquid aerosol-forming substrate. This liquid meniscus may generate aerosol during the heating of the susceptor. So also, the channels may constitute an evaporation zone. The first surface may be on an opposite side of the sheet to second surface. The at least one susceptor element may comprise a first thickness extending between the first surface and the second surface. Each channel of the plurality of channels may be defined at least partially on the first surface. Each channel of the plurality of channels may extend between 0.25 times and 0.75 times the first thickness from the first surface towards the second surface. Advantageously, the channel does not pass through the entirety of the susceptor element, maintaining robustness of the susceptor element. At least one channel of the plurality of channels may extend completely from the first surface to the second surface. Advantageously, when at least one channel of the plurality of channels extends completely from the first surface to the second surface, it is possible to have vaporization of the liquid aerosol-forming substrate through the channels, as well as transportation of the liquid aerosol-forming substrate through the channels. Not all channels of the plurality of channels may extend completely from the first surface to the second surface, so as to ensure that all portions of the susceptor element are connected by at least one portion of material. The first surface of the susceptor element may contact the wicking element. Preferably, the second surface of the susceptor element may contact the wicking element.

The at least one susceptor element may define a first plane. The plurality of channels may be configured to transport the aerosol-forming liquid in at least one direction within the first plane. Each channel of the plurality of channels may be obtained by chemical etching. Advantageously, the desired depth of the channels may be easily controlled. Each channel of the plurality of channels may extend between two apertures of the plurality of apertures. Each channel of the plurality of channels may extend between two adjacent apertures of the plurality of apertures. Each channel of the plurality of channels may extend between two nearest neighbour apertures of the plurality of apertures. Each aperture of the plurality of apertures may be connected to at least one adjacent aperture by at least one channel. The plurality of channels may form a regular array of channels. Each channel of the plurality of channels may be configured to exert a capillary force on the aerosol-forming liquid. Each channel may be a capillary channel. Each channel of the plurality of channels may be configured to transport liquid across a surface of the at least one susceptor element.

The plurality of channels may further comprise a plurality of peripheral channels, wherein each channel of the plurality of peripheral channels extends between one aperture of the plurality of apertures and a peripheral edge of the at least one susceptor element. Advantageously, such peripheral channels may facilitate liquid aerosol-forming substrate transportation between the peripheral edge of the at least one susceptor element, which may be in contact with a reservoir of liquid aerosol-forming substrate, and the centre of the at least one susceptor element.

Each channel of the plurality of channels may not extend between two apertures of the plurality of apertures. Each channel of the plurality of channels may not contact any apertures of the plurality of apertures. In such an arrangement, liquid may still be transported across the susceptor element and may be vaporised from the channels. In embodiments wherein each channel does not extend fully from the first surface to the second surface and wherein the second surface of the susceptor element contacts the wicking element, it may be advantageous for at least some of the channels of the plurality of channels to contact at least one peripheral edge of the susceptor element. Advantageously, such an arrangement of channels may facilitate liquid aerosol-forming substrate transportation between the peripheral edge of the at least one susceptor element, which may be in contact with a reservoir of liquid aerosol-forming substrate, towards the centre of the at least one susceptor element.

According to a second embodiment the present disclosure, there is provided a heating assembly comprising a susceptor assembly according to the present disclosure. In other words, the heating assembly may comprise a susceptor assembly, wherein the susceptor assembly may comprise at least one non-woven susceptor element. The at least one non-woven susceptor element may be in the form of a sheet. The at least one non-woven susceptor element may comprise a plurality of apertures. Each aperture may extend from a first surface of the sheet to a second surface of the sheet. The susceptor assembly may comprise a wicking element coupled to the at least one non-woven susceptor element. The wicking element may be configured to transport aerosol-forming liquid across a surface of the at least one non-woven susceptor element. Each aperture of the plurality of apertures may extend in a first direction parallel to at least one of the first and second surfaces of the at least one susceptor element. Each aperture of the plurality of apertures may extend in a second direction parallel to at least one of the first and second surfaces of the at least one susceptor element and perpendicular to the first direction. Each aperture of the plurality of apertures may extend a greater distance in the first direction than in the second direction.

The heating assembly may further comprise an inductor that at least in part surrounds the susceptor element. The inductor may be configured to generate a magnetic field that varies in a direction parallel to the first direction. The inductor may comprise at least one helical coil.

According to a third embodiment the present disclosure, there is provided a cartridge for coupling to an aerosol-generating device. The cartridge may comprise the heating assembly according to the second embodiment. The cartridge may comprise the susceptor assembly according to the first embodiment. In other words, the cartridge may comprise a susceptor assembly, wherein the susceptor assembly may comprise at least one non-woven susceptor element. The at least one non-woven susceptor element may be in the form of a sheet. The at least one non-woven susceptor element may comprise a plurality of apertures. Each aperture may extend from a first surface of the sheet to a second surface of the sheet. The susceptor assembly may comprise a wicking element coupled to the at least one non-woven susceptor element. The wicking element may be configured to transport aerosol-forming liquid across a surface of the at least one non-woven susceptor element. Each aperture of the plurality of apertures may extend in a first direction parallel to at least one of the first and second surfaces of the at least one susceptor element. Each aperture of the plurality of apertures may extend in a second direction parallel to at least one of the first and second surfaces of the at least one susceptor element and perpendicular to the first direction. Each aperture of the plurality of apertures may extend a greater distance in the first direction than in the second direction.

The heating assembly may further comprise an inductor that at least in part surrounds the susceptor element. The inductor may be configured to generate a magnetic field that varies in a direction parallel to the first direction. The inductor may comprise at least one helical coil.

The cartridge may comprise an air inlet and an air outlet. The cartridge may comprise an internally positioned cartridge airflow passage extending between the air inlet and the air outlet. The cartridge may comprise a reservoir for liquid aerosol-forming substrate. The susceptor element may be positioned at least partially in the cartridge airflow passage. The susceptor element may be positioned in the cartridge airflow passage. The reservoir may be in fluid communication with the wicking element of the susceptor assembly.

The cartridge may comprise a reservoir housing comprising the reservoir. The cartridge may comprise a susceptor holder positioned within the reservoir housing. The susceptor holder may at least partially define the cartridge airflow passage. The susceptor holder may be coupled to the susceptor assembly. The susceptor element may be positioned at least partially within the cartridge airflow passage. The susceptor element may at least partially span or extend across the cartridge airflow passage. The susceptor element may extend from one side of the cartridge airflow passage to another side of the cartridge airflow passage. When the susceptor element is a planar susceptor element, the longitudinal direction of the airflow passage may lie within the plane formed by the susceptor element.

The susceptor holder may comprise a thermally insulative material. The susceptor holder may comprise an electrically insulative material. The susceptor holder may comprise at least one polymer. The susceptor holder may comprise polyether ether ketone (PEEK). The susceptor holder may be formed by injection moulding. Advantageously, injection moulding may simplify manufacturing of the cartridge. The susceptor element may extend across the cartridge airflow passage. The second region may be positioned in the centre of the cartridge airflow passage. The second region may be positioned near or in the axial centre of the cartridge airflow passage. It is this region, near or at the axial centre of the cartridge airflow passage which is prone to overheating and scorching of the wicking element due to insufficient liquid supply. By locating the second region near or at the axial centre of the cartridge airflow passage, such risks may be reduced. The first region may be positioned in the cartridge airflow passage at least partially between the second region and the reservoir.

The susceptor element may comprise a first mounting region at a first edge of the susceptor element in contact with the susceptor holder, and a second mounting region at a second edge of the susceptor element, opposite the first edge, in contact with the susceptor holder. The cartridge airflow passage may extend substantially along a longitudinal axis. The susceptor element may be substantially planar, and the susceptor element may extend parallel to the longitudinal axis. The first direction may be parallel to the longitudinal axis. The cartridge may be configured to be heated by a magnetic field varying in a direction parallel to the first direction. The cartridge may be configured to be coupled to an aerosol-generating system wherein the susceptor element may be heated by a magnetic field varying in a direction parallel to the first direction. Advantageously, it has been found that in such an arrangement extension of the apertures in the second direction perpendicular to the direction of the varying magnetic field does not contribute significantly to power and heat generation by induction. Therefore, it is beneficial to dispose the susceptor element such that the elongated direction of the apertures is aligned with the direction of the varying magnetic field.

Each channel of the plurality of channels may extend from a peripheral region of the susceptor element towards a centre of the susceptor element. Each channel of the plurality of channels may extend from a region of the susceptor element adjacent to the reservoir towards a region of the susceptor element furthest from the reservoir. Advantageously, the channels may therefore assist in delivering aerosol-forming substrate across the susceptor element to regions furthest from the reservoir where liquid aerosol-forming substrate supply may be otherwise hindered by slow diffusion rates. Each channel of the plurality of channels may extend substantially perpendicular to the longitudinal axis. Liquid aerosol-forming substrate may be delivered to the susceptor assembly from the reservoir in a direction perpendicular to the longitudinal axis of the airflow passage. Advantageously, the plurality of channels extending substantially perpendicular to the longitudinal axis may therefore assist in delivering aerosol-forming substrate across the entirety of the susceptor element. Each channel of the plurality of channels may extend either substantially parallel to the longitudinal axis or substantially perpendicular to the longitudinal axis. When liquid supply in the reservoir is low, the liquid aerosol-forming substrate supplied to the susceptor assembly may be supplied over only portions of the peripheral edges of the susceptor assembly in contact with the reservoir. The channels extending parallel to the longitudinal axis of the airflow passage may therefore assist in delivering aerosol-forming substrate across the entirety of the susceptor element to regions furthest from the portions of the peripheral edges to which liquid aerosol-forming substrate is supplied. Each channel of the plurality of channels may be positioned at least partially within the cartridge airflow passage.

At least one channel of the plurality of peripheral channels may extend towards the reservoir from at least one aperture of the plurality of apertures. At least one channel of the plurality of peripheral channels may be in fluidic communication with the reservoir. Advantageously, the at least one channel of the plurality of peripheral channels may exert a capillary force on liquid in the reservoir to draw liquid from the reservoir into the airflow passage.

The liquid reservoir may surround the cartridge airflow passage. The aerosol-forming substrate is liquid at room temperature. The aerosol-forming substrate may comprise nicotine. The aerosol-forming substrate may comprise one or more aerosol-formers. The one or more aerosol-formers may comprise glycerine and/or propylene glycol.

According to a fourth embodiment of the present disclosure, there is provided an aerosol-generating system. The aerosol-generating system may comprise an aerosol-generating device and a cartridge according to the third embodiment of the present disclosure. In other words, the aerosol-generating system may comprise an aerosol-generating device and a cartridge, wherein the cartridge may comprise a susceptor assembly, wherein the susceptor assembly may comprise at least one non-woven susceptor element. The at least one non-woven susceptor element may be in the form of a sheet. The at least one non-woven susceptor element may comprise a plurality of apertures. Each aperture may extend from a first surface of the sheet to a second surface of the sheet. The susceptor assembly may comprise a wicking element coupled to the at least one non-woven susceptor element. The wicking element may be configured to transport aerosol-forming liquid across a surface of the at least one non-woven susceptor element. Each aperture of the plurality of apertures may extend in a first direction parallel to at least one of the first and second surfaces of the at least one susceptor element. Each aperture of the plurality of apertures may extend in a second direction parallel to at least one of the first and second surfaces of the at least one susceptor element and perpendicular to the first direction. Each aperture of the plurality of apertures may extend a greater distance in the first direction than in the second direction. The cartridge may be configured to be couplable to the aerosol-generating device. The aerosol-generating device may comprise a device airflow inlet and a device airflow outlet. The aerosol-generating device may comprise a device airflow passage extending between the device airflow inlet and the device airflow outlet. The aerosol-generating device may comprise an inductor. The inductor may at least in part surrounds the susceptor element when the cartridge is coupled to the aerosol-generating device. The aerosol-generating device may comprise a power supply, such as a battery. The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

The device may further comprise control circuitry. The control circuitry may be configured to control the supply of power from the battery to the inductor. Advantageously, different power profiles may be supplied to the inductor by the control circuitry dependent on the aerosol generation required. The control circuitry may further comprise a sensor. The sensor may be configured to be in fluid communication with the airflow passage when the cartridge is coupled to the aerosol-generating device. The control circuitry may be configured to detect when a user is puffing on the system based on a signal from the sensor. The sensor may be an airflow sensor. The sensor may be a pressure sensor. The aerosol-generating system may be configured such that the power supplied to the inductor is based on a signal from the sensor. Advantageously, power may then only be supplied to the inductor by the control circuitry when the user is puffing on the aerosol-generating system. The control circuitry may control a temperature of the susceptor element. The control circuitry may comprise a microcontroller. The microcontroller may be a programmable microcontroller.

The control circuitry may be configured to supply an alternating current to the inductor to generate a magnetic field. The susceptor element may be at least partially within the magnetic field generated by the inductor when the cartridge is coupled to the aerosol-generating device.

When an alternating current is supplied to the inductor, a temperature of the first region may increase more than a temperature of the second region. Advantageously, this may reduce the risk of overheating of the second region in particular, and hence reduce the risk of wick scorching adjacent to the second region.

The inductor may comprise at least one helical coil. The inductor may comprise only one helical coil. The inductor may comprise copper.

The aerosol-generating device may comprise a cavity, into which at least part of the cartridge is located when the cartridge is coupled to the aerosol-generating device.

The device air outlet may be in fluid communication with the air inlet of the cartridge when the cartridge is coupled to the aerosol-generating device, such that a system airflow passage is defined between the device air inlet and the air outlet of the cartridge.

The magnetic field generated by the inductor may be parallel to the longitudinal axis of the airflow passage. The susceptor assembly may be configured to be arranged within the cartridge such that the susceptor element may be heated by a magnetic field varying in a direction parallel to the first direction. Advantageously, it has been found that in such an arrangement extension of the apertures in the second direction perpendicular to the direction of the varying magnetic field does not contribute significantly to power and heat generation by induction. Therefore, it is beneficial to dispose the susceptor element such that the elongated direction of the apertures is aligned with the direction of the varying magnetic field.

According to a fifth embodiment of the present disclosure, there is provided an aerosol-generating device. The aerosol-generating device may comprise a susceptor assembly according to the first embodiment.

In other words, the aerosol-generating device may comprise a susceptor assembly, wherein the susceptor assembly may comprise at least one non-woven susceptor element. The at least one non-woven susceptor element may be in the form of a sheet. The at least one non-woven susceptor element may comprise a plurality of apertures. Each aperture may extend from a first surface of the sheet to a second surface of the sheet. The susceptor assembly may comprise a wicking element coupled to the at least one non-woven susceptor element. The wicking element may be configured to transport aerosol-forming liquid across a surface of the at least one non-woven susceptor element. Each aperture of the plurality of apertures may extend in a first direction parallel to at least one of the first and second surfaces of the at least one susceptor element. Each aperture of the plurality of apertures may extend in a second direction parallel to at least one of the first and second surfaces of the at least one susceptor element and perpendicular to the first direction. Each aperture of the plurality of apertures may extend a greater distance in the first direction than in the second direction.

The aerosol-generating device may further comprise an air inlet and an air outlet. The aerosol-generating device may further comprise an internally positioned airflow passage extending between the air inlet and the air outlet. The aerosol-generating device may further comprise a reservoir for liquid aerosol-forming substrate. The reservoir may be in fluid communication with the wicking element of the susceptor assembly. The aerosol-generating device may further comprise an inductor. The inductor may at least in part surrounds the susceptor element. The aerosol-generating device may further comprise a power supply, such as a battery. The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

The device may further comprise control circuitry. The control circuitry may be configured to control the supply of power from the battery to the inductor. Advantageously, different power profiles may be supplied to the inductor by the control circuitry dependent on the aerosol generation required. The control circuitry may further comprise a sensor. The sensor may be configured to be in fluid communication with the device airflow passage. The control circuitry may be configured to detect when a user is puffing on the device based on a signal from the sensor. The sensor may be an airflow sensor. The sensor may be a pressure sensor. The aerosol-generating device may be configured such that the power supplied to the inductor is based on a signal from the sensor. Advantageously, power may then only be supplied to the inductor by the control circuitry when the user is puffing on the aerosol-generating device. The control circuitry may control a temperature of the susceptor element. The control circuitry may comprise a microcontroller. The microcontroller may be a programmable microcontroller.

The control circuitry may be configured to supply an alternating current to the inductor to generate a magnetic field. The susceptor element may be positioned in the airflow passage, such that the susceptor element is at least partially within the magnetic field generated by the inductor.

When an alternating current is supplied to the inductor, a temperature of the first region may increase more than a temperature of the second region. Advantageously, this may reduce the risk of overheating of the second region in particular, and hence reduce the risk of wick scorching adjacent to the second region.

The inductor may comprise at least one helical coil. The inductor may comprise only one helical coil. The inductor may comprise copper.

The device may comprise a reservoir housing comprising the reservoir. The device may comprise a susceptor holder positioned within the reservoir housing. The susceptor holder may at least partially define the device airflow passage. The susceptor holder may be coupled to the susceptor assembly. The susceptor element may be positioned at least partially within the device airflow passage. The susceptor element may at least partially span or extend across the device airflow passage. The susceptor element may extend from one side of the device airflow passage to another side of the device airflow passage. When the susceptor element is a planar susceptor element, the longitudinal direction of the airflow passage may lie within the plane formed by the susceptor element.

The susceptor holder may comprise a thermally insulative material. The susceptor holder may comprise an electrically insulative material. The susceptor holder may comprise at least one polymer. The susceptor holder may comprise polyether ether ketone (PEEK). The susceptor holder may be formed by injection moulding. Advantageously, injection moulding may simplify manufacturing of the cartridge. The susceptor element may extend across the cartridge airflow passage. The second region may be positioned in the centre of the device airflow passage. The second region may be positioned near or in the axial centre of the cartridge airflow passage. It is this region, near or at the axial centre of the device airflow passage which is prone to overheating and scorching of the wicking element due to insufficient liquid supply. By locating the second region near or at the axial centre of the device airflow passage, such risks may be reduced. The first region may be positioned in the device airflow passage at least partially between the second region and the reservoir.

The susceptor element may comprise a first mounting region at a first edge of the susceptor element in contact with the susceptor holder, and a second mounting region at a second edge of the susceptor element, opposite the first edge, in contact with the susceptor holder. The device airflow passage may extend substantially along a longitudinal axis. The susceptor element may be substantially planar, and the susceptor element may extend parallel to the longitudinal axis. The first direction may be parallel to the longitudinal axis. The susceptor element may be configured to be heated by a magnetic field varying in a direction parallel to the first direction. The magnetic field generated by the inductor may be parallel to the longitudinal axis of the airflow passage. The susceptor assembly may be configured to be arranged within the device such that the susceptor element may be heated by a magnetic field varying in a direction parallel to the first direction. Advantageously, it has been found that in such an arrangement extension of the apertures in the second direction perpendicular to the direction of the varying magnetic field does not contribute significantly to power and heat generation by induction. Therefore, it is beneficial to dispose the susceptor element such that the elongated direction of the apertures is aligned with the direction of the varying magnetic field.

Each channel of the plurality of channels may extend either substantially parallel to the longitudinal axis or substantially perpendicular to the longitudinal axis. Each channel of the plurality of channels may be positioned at least partially within the device airflow passage.

At least one channel of the plurality of peripheral channels may extend towards the reservoir from at least one aperture of the plurality of apertures. At least one channel of the plurality of peripheral channels may be in fluidic communication with the reservoir. Advantageously, the at least one channel of the plurality of peripheral channels may exert a capillary force on liquid in the reservoir to draw liquid from the reservoir into the airflow passage.

The liquid reservoir may surround the device airflow passage. The aerosol-forming substrate may be liquid at room temperature. The aerosol-forming substrate may comprise nicotine. The aerosol-forming substrate may comprise one or more aerosol-formers. The one or more aerosol-formers may comprise glycerine and/or propylene glycol.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, an “aerosol-generating system” means a system that generates an aerosol from one or more aerosol-forming substrates.

As used herein, an “aerosol-generating device” may mean a device that generates an aerosol from one or more aerosol-forming substrates. The “aerosol-generating device” may be configured to generate an aerosol from one or more aerosol-forming substrates when a cartridge comprising the one or more aerosol-forming substrates is coupled to the “aerosol-generating device”. In other embodiments, the “aerosol-generating device” may comprise the one or more aerosol-forming substrates.

As used herein, the term “aerosol-forming substrate” means a substrate capable of releasing volatile compounds that may form an aerosol. Such volatile compounds may be released by heating the aerosol-forming substrate.

As used herein, the term “puff” is used to describe the action of a user generating aerosol using the aerosol-generating system or device. The user carries out this action by drawing air through the aerosol-generating system or device by inhalation.

As used herein, the term “session” refers to a period in which the aerosol-generating system or device is activated, for example by a user, and comprises at least one puff. During the session, the aerosol-generating system or device may automatically detect a puff, as described above, and power the susceptor element accordingly.

As used herein, the terms “air inlet’ and ‘air outlet” are used to describe one or more apertures through which air may be drawn into, and out of, respectively, of a component or portion of a component of the cartridge, aerosol-generating system or aerosol-generating device.

As used herein, the term “cartridge” also refers to an article comprising an aerosol-forming substrate that is capable of releasing volatile compounds that can form an aerosol. A cartridge also may be disposable.

A cartridge may contain a liquid. The liquid may comprise volatile compounds that may form an aerosol. The liquid may form an aerosol upon heating of the liquid. The aerosol-forming substrate may be a liquid. The aerosol-forming substrate may be a liquid at room temperature. The aerosol-forming substrate may be in another condensed form, such as a solid at room temperature, or may be in another condensed form, such as a gel, at room temperature. Volatile compounds may be released by heating the aerosol-forming substrate. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours. The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

The aerosol-generating system or device may be a handheld aerosol-generating system or device. The aerosol-generating system or device may be a handheld aerosol-generating system or device configured to allow a user to suck on a mouthpiece to draw an aerosol through a first air outlet. The aerosol-generating system or device may have a size comparable to a conventional cigar or cigarette. The aerosol-generating system or device may have a total length between about 25 mm and about 150 mm. The aerosol-generating system or device may have an external diameter between about 5 mm and about 30 mm.

The invention is defined in the claims. However, below there is provided a non-exhaustive list of non-limiting examples. Any one or more of the features of these examples may be combined with any one or more features of another example, embodiment, or aspect described herein.

Example Ex1. A susceptor assembly for an aerosol-generating system, the susceptor assembly comprising:
at least one non-woven susceptor element, the at least one non-woven susceptor element in the form of a sheet, and comprising a plurality of apertures, each aperture extending from a first surface of the sheet to a second surface of the sheet; and
a wicking element coupled to the at least one non-woven susceptor element, the wicking element configured to transport aerosol-forming liquid across a surface of the at least one non-woven susceptor element;
wherein each aperture of the plurality of apertures extends in a first direction parallel to at least one of the first and second surfaces of the at least one susceptor element,
wherein each aperture of the plurality of apertures extends in a second direction parallel to at least one of the first and second surfaces of the at least one susceptor element and perpendicular to the first direction, and
wherein each aperture of the plurality of apertures extends a greater distance in the first direction than in the second direction.

Example Ex2. A susceptor assembly according to Example Ex1, wherein each aperture of the plurality of apertures extends by a first distance in the first direction, and each aperture of the plurality of apertures extends by a second distance in the second direction, and wherein the first distance is greater than the second distance.

Example Ex3. A susceptor assembly according to Example Ex2, wherein the first distance is between 1.5 and 10 times that of the second distance.

Example Ex4. A susceptor assembly according to Example Ex3, wherein the first distance is between 2 and 5 times that of the second distance.

Example Ex5. A susceptor assembly according to Example Ex4, wherein the first distance is between 2.5 and 4 times that of the second distance.

Example Ex6. A susceptor assembly according to any of Examples Ex2 to Ex5, wherein the susceptor element is planar and defines a first plane, such that the first and second directions are within the first plane.

Example Ex7. A susceptor assembly according to any of Examples Ex2 to Ex6, wherein the plurality of apertures form a regular array of apertures in the at least one susceptor element.

Example Ex8. A susceptor assembly according to Example Ex7, wherein the plurality of apertures are spaced in the first direction by a first spacing distance between 0.05 and 1 times the first distance.

Example Ex9. A susceptor assembly according to Example Ex8, wherein the plurality of apertures are spaced in the first direction by a first spacing distance between 0.1 and 0.5 times the first distance.

Example Ex10. A susceptor assembly according to any of Examples Ex7 to Ex9, wherein the plurality of apertures are spaced in the second direction by a second spacing distance between 0.2 and 5 times the second distance.

Example Ex11. A susceptor assembly according to Example Ex10, wherein the plurality of apertures are spaced in the second direction by a second spacing distance between 1 and 3 times the second distance.

Example Ex12. A susceptor assembly according to any of Examples Ex7 to Ex11, wherein the regular array of apertures is a hexagonal array of apertures.

Example Ex13. A susceptor assembly according to any of Examples Ex7 to Ex11, wherein the regular array of apertures is a square or rectangular array of apertures.

Example Ex14. A susceptor assembly according to any preceding Example, wherein the wicking element comprises first and second planar surfaces, the first and second surfaces defining opposite, outward-facing surfaces of the wicking element.

Example Ex15. A susceptor assembly according to Example Ex14, wherein the at least one susceptor element comprises a first and a second planar susceptor element, and wherein the susceptor assembly is arranged such that the first surface of the wicking element contacts the first susceptor element and the second surface of the wicking element contacts the second susceptor element.

Example Ex16. A susceptor assembly according to Example Ex15, wherein the at least one susceptor element is folded around the wicking element, such that the first surface of the wicking element contacts a first portion of the at least one susceptor element and the second surface of the wicking element contacts a second portion of the at least one susceptor element, wherein the first portion is substantially parallel to the second portion.

Example Ex17. A susceptor assembly according to Example Ex16, wherein the at least one susceptor element further comprises a folded portion, wherein the folded portion is connected between the first portion and the second portion.

Example Ex18. A susceptor assembly according to Example Ex17, wherein the folded portion comprises an elongated aperture, the elongated aperture extending in a direction parallel to at least one of the first and second surfaces of the wicking element.

Example Ex19. A susceptor assembly according to any of Examples Ex16 to Ex18, wherein the first portion of the at least one susceptor element and the second portion of the at least one susceptor element are integrally formed.

Example Ex20. A susceptor assembly according to any preceding Example, wherein each aperture of the plurality of apertures is circular or oval in shape.

Example Ex21. A susceptor assembly according to any of Examples Ex1 to Ex19, wherein each aperture of the plurality of apertures is rectangular or square in shape.

Example Ex22. A susceptor assembly according to any preceding Example, wherein the at least one susceptor element has a first thickness, and wherein the first thickness is between 25 micrometres and 100 micrometres.

Example Ex23. A susceptor assembly according to any preceding Example, wherein each aperture of the plurality of apertures is formed via laser cutting.

Example Ex24. A susceptor assembly according to any of Examples Ex1 to Ex22, wherein each aperture of the plurality of apertures is formed via chemical etching.

Example Ex25. A susceptor assembly according to any of Examples Ex1 to Ex22, wherein each aperture of the plurality of apertures is formed via stamping or wire electrical discharge.

Example Ex26. A susceptor assembly according to any preceding Example, wherein the at least one susceptor element comprises at least one outward protrusion, the at least one outward protrusion positioned on a peripheral edge of the at least one susceptor element.

Example Ex27. A susceptor assembly according to Example Ex26, wherein the at least one outward protrusion is configured to engage a susceptor holder component of a cartridge.

Example Ex28. A susceptor assembly according to Example Ex26 or Ex27, wherein the at least one outward protrusion occupies a percentage of the peripheral edge of the at least one susceptor element.

Example Ex29. A susceptor assembly according to Example Ex28, wherein the proportion is between 1% and 20% of the peripheral edge of the at least one susceptor element.

Example Ex30. A susceptor assembly according to Example Ex29, wherein the proportion is between 2% and 10% of the peripheral edge of the at least one susceptor element.

Example Ex31. A susceptor assembly according to any preceding Example, wherein the at least one susceptor element is heatable by at least one of Joule heating through induction of eddy currents in the susceptor element, and hysteresis losses.

Example Ex32. A susceptor assembly according to any preceding Example, wherein the at least one susceptor element comprises at least one of graphite, molybdenum, silicon carbide, stainless steels, niobium and aluminium.

Example Ex33. A susceptor assembly according to any preceding Example, wherein the at least one susceptor element comprises at least one ferromagnetic material.

Example Ex34. A susceptor assembly according to any preceding Example, wherein the at least one susceptor element comprises AISI 430 stainless steel.

Example Ex35. A susceptor assembly according to any preceding Example, wherein the at least one susceptor element has a relative permeability between 1 and 40000, when measured at frequencies up to 10 kHz at a temperature of 20 degrees Celsius.

Example Ex36. A susceptor assembly according to Example Ex35, wherein the at least one susceptor element has a relative permeability between 500 and 40000, when measured at frequencies up to 10 kHz at a temperature of 20 degrees Celsius.

Example Ex37. A susceptor assembly according to any preceding Example, wherein the at least one susceptor element is substantially flat.

Example Ex38. A susceptor assembly according to any preceding Example, wherein the at least one susceptor element is fluid permeable.

Example Ex39. A susceptor assembly according to any preceding Example, wherein the at least one non-woven susceptor element comprises a first region, the first region comprising a first configuration of apertures of the plurality of apertures, wherein the at least one non-woven susceptor element comprises a second region, the second region comprising a second configuration of apertures of the plurality of apertures, and wherein the second configuration of apertures is different from the first configuration of apertures.

Example Ex40. A susceptor assembly according to Example Ex39, wherein the second configuration of apertures comprises no apertures, such that the second region comprises no apertures.

Example Ex41. A susceptor assembly according to Example Ex39 or Ex40, wherein the second configuration of apertures is different from the first configuration of apertures such that a temperature of the first region increases more than a temperature of the second region when the first region is exposed to an identical alternating magnetic field as the second region, and when the alternating magnetic field is uniform across the first and second regions.

Example Ex42. A susceptor assembly according to any of Examples Ex39 to Ex41, wherein the first region comprises a first density of apertures of the plurality of apertures, and wherein the second region comprises a second density of apertures of the plurality of apertures, and wherein the second density of apertures is different from the first density of apertures.

Example Ex43. A susceptor assembly according to Example Ex42, wherein the second density of apertures is less than the first density of apertures.

Example Ex44. A susceptor assembly according to Example Ex43, wherein the second density of apertures is equal to zero, such that the second region comprises no apertures.

Example Ex45. A susceptor assembly according to any of Examples Ex39 to Ex44, wherein the second region comprises a shape comprising a central region of the susceptor element.

Example Ex46. A susceptor assembly according to Example Ex45, wherein the shape of the second region further comprises a plurality of radial portions, the plurality of radial portions extending in the first plane across the susceptor element from the central region towards a periphery of the planar susceptor element.

Example Ex47. A susceptor assembly according to Example Ex46, wherein each of the radial portions of the plurality of radial portions are uniformly spaced from one another in the first plane about the central region.

Example Ex48. A susceptor assembly according to Example Ex46 or Ex47, wherein the second region comprises between 2 and 8 radial portions.

Example Ex49. A susceptor assembly according to Example Ex48, wherein the second region comprises between 4 and 6 radial portions.

Example Ex50. A susceptor assembly according to any preceding Example, wherein each aperture of the plurality of apertures is equal in size.

Example Ex51. A susceptor assembly according to any preceding Example, wherein a size of each of the apertures in the first region is different from a size of each of the apertures in the second region.

Example Ex52. A susceptor assembly according to Example Ex51, wherein the size of each of the apertures in the first region is less than the size of each of the apertures in the second region.

Example Ex53. A susceptor assembly according to Example Ex52, wherein a first mean size of the apertures in the first region is less than a second mean size of the apertures in the second region.

Example Ex54. A susceptor assembly according to any of Examples Ex51 to Ex53, wherein the size of each of the apertures is a cross sectional area of each of the apertures parallel to the first surface of the at least one susceptor element.

Example Ex55. A susceptor assembly according to any preceding Example, wherein the first region comprises a first regular array of apertures of the plurality of apertures.

Example Ex56. A susceptor assembly according to Example Ex55, wherein the first regular array of apertures is a hexagonal array of apertures.

Example Ex57. A susceptor assembly according to Example Ex55, wherein the first regular array of apertures is a square array of apertures.

Example Ex58. A susceptor assembly according to any preceding Example, wherein the second region comprises a second regular array of apertures of the plurality of apertures.

Example Ex59. A susceptor assembly according to Example Ex58, wherein the second regular array of apertures is a hexagonal array of apertures.

Example Ex60. A susceptor assembly according to Example Ex58, wherein the second regular array of apertures is a square array of apertures.

Example Ex61. A susceptor assembly according to any preceding Example, wherein the at least one non-woven susceptor element further comprises a plurality of channels, each channel of the plurality of channels extending between at least two apertures of the plurality of apertures.

Example Ex62. A susceptor assembly according to Example Ex61, wherein the first surface is on an opposite side of the sheet to second surface, and the at least one susceptor element comprises a first thickness extending between the first surface and the second surface, and wherein each channel of the plurality of channels is defined at least partially on the first surface.

Example Ex63. A susceptor assembly according to Example Ex62, wherein the each channel of the plurality of channels extends between 0.25 times and 0.75 times the first thickness from the first surface towards the second surface.

Example Ex64. A susceptor assembly according to Example Ex62, wherein at least one channel of the plurality of channels extends completely from the first surface to the second surface.

Example Ex65. A susceptor assembly according to any of Examples Ex62 to Ex64, wherein the second surface of the susceptor element contacts the wicking element.

Example Ex66. A susceptor assembly according to any of Examples Ex62 to Ex64, wherein the at least one susceptor element defines a first plane.

Example Ex67. A susceptor assembly according to any of Examples Ex61 to Ex66, wherein each channel of the plurality of channels is configured to transport the aerosol-forming liquid in at least one direction within the first plane.

Example Ex68. A susceptor assembly according to any of Examples Ex61 to Ex67, wherein each channel of the plurality of channels is obtained by chemical etching.

Example Ex69. A susceptor assembly according to any of Examples Ex61 to Ex68, wherein each channel of the plurality of channels extends between two apertures of the plurality of apertures, preferably wherein each channel of the plurality of channels extends between two adjacent apertures of the plurality of apertures.

Example Ex70. A susceptor assembly according to Example Ex69, wherein each aperture of the plurality of apertures is connected to at least one adjacent aperture by at least one channel.

Example Ex71. A susceptor assembly according to any of Examples Ex61 to Ex70, wherein the plurality of channels forms a regular array of channels.

Example Ex72. A susceptor assembly according to any of Examples Ex61 to Ex71, wherein each channel of the plurality of channels is configured to exert a capillary force on the aerosol-forming liquid.

Example Ex73. A susceptor assembly according to any of Examples Ex61 to Ex72, wherein the plurality of channels further comprises a plurality of peripheral channels, wherein each channel of the plurality of peripheral channels extends between one aperture of the plurality of apertures and a peripheral edge of the at least one susceptor element.

Example Ex74. A heating assembly comprising a susceptor assembly according to any preceding Example, wherein the heating assembly further comprises an inductor that at least in part surrounds the susceptor element, wherein the inductor is configured to generate a magnetic field that varies in a direction parallel to the first direction.

Example Ex75. A heating assembly according to Ex74, wherein the inductor comprises at least one helical coil.

Example Ex76. A cartridge for coupling to an aerosol-generating device, the cartridge comprising a susceptor assembly according to any one of Examples Ex1 to Ex73, wherein the cartridge comprises:
an air inlet and an air outlet;
an internally positioned cartridge airflow passage extending between the air inlet and the air outlet, and
a reservoir for liquid aerosol-forming substrate,
wherein the cartridge is configured to receive the susceptor assembly such that the susceptor element is positioned in the cartridge airflow passage with the reservoir in fluid communication with the wicking element of the susceptor assembly.

Example Ex77. A cartridge according to Example Ex76, wherein the cartridge comprises a reservoir housing comprising the reservoir, and a susceptor holder positioned within the reservoir housing, the susceptor holder at least partially defining the cartridge airflow passage, the susceptor holder coupled to the susceptor assembly, and wherein the susceptor element is positioned at least partially within the cartridge airflow passage.

Example Ex78. A cartridge according to Example Ex77, wherein the susceptor holder comprises a thermally insulative material.

Example Ex79. A cartridge according to Example Ex77 or Ex78, wherein the susceptor holder comprises an electrically insulative material.

Example Ex80. A cartridge according to any of Examples Ex76 to Ex79, wherein the susceptor element extends across the cartridge airflow passage.

Example Ex81. A cartridge according to Example Ex80 when dependent on Ex39, wherein the second region is positioned in the centre of the cartridge airflow passage.

Example Ex82. A cartridge according to Example Ex81, wherein the first region is positioned in the cartridge airflow passage at least partially between the second region and the reservoir.

Example Ex83. A cartridge according to any of Examples Ex77 to Ex82, wherein the susceptor element comprises a first mounting region at a first edge of the susceptor element in contact with the susceptor holder, and a second mounting region at a second edge of the susceptor element, opposite the first edge, in contact with the susceptor holder.

Example Ex84. A cartridge according to any of Examples Ex76 to Ex83, wherein the cartridge airflow passage extends substantially along a longitudinal axis, and the susceptor element is substantially planar, and the susceptor element extends parallel to the longitudinal axis.

Example Ex85. A cartridge according to Example Ex84, wherein the first direction is parallel to the longitudinal axis.

Example Ex86. A cartridge according to Example Ex84 or Ex85 when dependent on Example Ex63, wherein each channel of the plurality of channels extends either substantially parallel to the longitudinal axis or substantially perpendicular to the longitudinal axis.

Example Ex87. A cartridge according to Example Ex86, wherein each channel of the plurality of channels is positioned within the cartridge airflow passage.

Example Ex88. A cartridge according to Example Ex86 or Ex87 when dependent on Example Ex73, wherein at least one peripheral channel of the plurality of peripheral channels extends towards the reservoir from at least one aperture of the plurality of apertures.

Example Ex89. A cartridge according to Example Ex88, wherein at least one peripheral channel of the plurality of peripheral channels is in fluidic communication with the reservoir.

Example Ex90. A cartridge according to any of Examples Ex76 to Ex89, wherein the liquid reservoir surrounds the cartridge airflow passage.

Example Ex91. A cartridge according to any of Examples Ex76 to Ex90, wherein the aerosol-forming substrate is liquid at room temperature.

Example Ex92. A cartridge according to any of Examples Ex76 to Ex91, wherein the aerosol-forming substrate comprises nicotine.

Example Ex93. A cartridge according to any of Examples Ex786 to Ex92, wherein the aerosol-forming substrate comprises one or more aerosol-formers.

Example Ex94. A cartridge according to Example Ex93, wherein the one or more aerosol-formers comprises glycerine and/or propylene glycol.

Example Ex95. An aerosol-generating system comprising an aerosol-generating device and a cartridge according to any one of Examples Ex76 to Ex94, the cartridge configured to be couplable to the aerosol-generating device, the aerosol-generating device comprising:
a device airflow inlet and a device airflow outlet,
a device airflow passage extending between the device airflow inlet and the device airflow outlet,
an inductor that at least in part surrounds the susceptor element when the cartridge is coupled to the aerosol-generating device, and
a battery, the battery configured to supply an alternating current to the inductor to generate a magnetic field, such that the susceptor element is at least partially within the magnetic field generated by the inductor when the cartridge is coupled to the aerosol-generating device.

Example Ex96. An aerosol-generating system according to Example Ex95 when dependent on Ex39, wherein when an alternating current is supplied to the inductor, a temperature of the first region increases more than a temperature of the second region.

Example Ex97. An aerosol-generating system according to Example Ex95 or Ex6, wherein the inductor comprises at least one helical coil.

Example Ex98. An aerosol-generating system according to Example Ex97, wherein the inductor comprises only one helical coil.

Example Ex99. An aerosol-generating system according to any one of Examples Ex95 to Ex198, wherein the inductor comprises copper.

Example Ex100. An aerosol-generating system according to any of Examples Ex95 to Ex99, wherein the aerosol-generating device comprises a cavity, into which at least part of the cartridge is located when the cartridge is coupled to the aerosol-generating device.

Example Ex101. An aerosol-generating system according to any of Examples Ex95 to Ex100, wherein the device air outlet is in fluid communication with the air inlet of the cartridge when the cartridge is coupled to the aerosol-generating device, such that a system airflow passage is defined between the device air inlet and the air outlet of the cartridge.

Example Ex102. An aerosol-generating system according to any of Examples Ex95 to Ex101, wherein the device further comprises control circuitry, the control circuitry configured to control the supply of power from the battery to the inductor.

Example Ex103. An aerosol-generating system according to Example Ex102, wherein the control circuitry further comprises a sensor, the sensor configured to be in fluid communication with the device airflow passage when the cartridge is coupled to the aerosol-generating device, and the aerosol-generating system is configured such that the power supplied to the inductor is based on a signal from the sensor.

Example Ex104. An aerosol-generating system according to any of Examples Ex95 to Ex103, wherein the magnetic field generated by the inductor varies in a direction parallel to the first direction.

Example Ex105. An aerosol-generating device, the aerosol-generating device comprising the susceptor assembly according to any one of Examples Ex1 to Ex73, wherein the aerosol-generating device comprises:
an air inlet and an air outlet;
an internally positioned airflow passage extending between the air inlet and the air outlet,
a reservoir for liquid aerosol-forming substrate, wherein the reservoir is in fluid communication with the wicking element of the susceptor assembly,
an inductor that at least in part surrounds the susceptor element when the cartridge is coupled to the aerosol-generating device, and
a battery, the battery configured to supply an alternating current to the inductor to generate a magnetic field,
wherein the susceptor element is positioned in the airflow passage, such that the susceptor element is at least partially within the magnetic field generated by the inductor.

Example Ex106. An aerosol-generating device according to Example Ex105 when dependent on Ex39, wherein when an alternating current is supplied to the inductor, a temperature of the first region increases more than a temperature of the second region.

Example Ex107. An aerosol-generating device according to Example Ex105 or Ex106, wherein the inductor comprises at least one helical coil.

Example Ex108. An aerosol-generating device according to Example Ex107, wherein the inductor comprises only one helical coil.

Example Ex109. An aerosol-generating device according to any one of Examples Ex105 to Ex108, wherein the inductor comprises copper.

Example Ex110. An aerosol-generating device according to any of Examples Ex105 to Ex109, wherein the device air outlet is in fluid communication with the air inlet of the cartridge when the cartridge is coupled to the aerosol-generating device, such that a system airflow passage is defined between the device air inlet and the air outlet of the cartridge.

Example Ex111. An aerosol-generating device according to any of Examples Ex105 to Ex110, wherein the device further comprises control circuitry, the control circuitry configured to control the supply of power from the battery to the inductor.

Example Ex112. An aerosol-generating device according to Example Ex111, wherein the control circuitry further comprises a sensor, the sensor in fluid communication with the airflow passage, and wherein the aerosol-generating device is configured such that the power supplied to the inductor is based on a signal from the sensor.

Example Ex113. An aerosol-generating device according to any of Examples Ex105 to Ex112, wherein the airflow passage extends substantially along a longitudinal axis, and the susceptor element is substantially planar, and the susceptor element extends parallel to the longitudinal axis

Example Ex114. An aerosol-generating device according to Example Ex113, wherein the magnetic field generated by the inductor varies in a direction parallel to the first direction.

Examples will now be further described with reference to the figures in which:

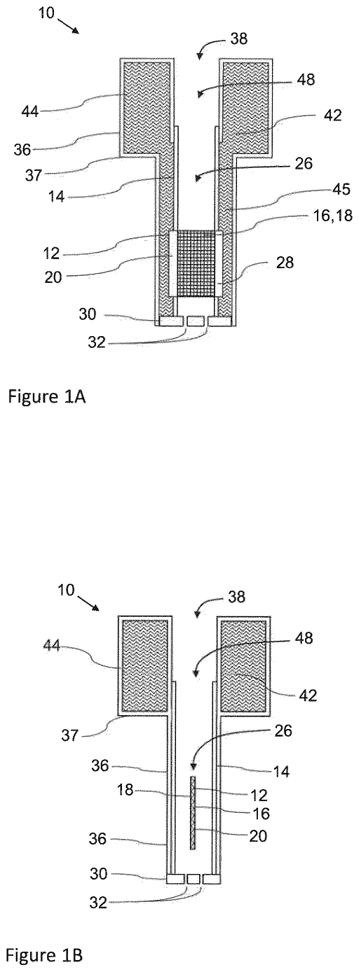

FIG. 1A shows a schematic illustration of a cross section of a cartridge for an aerosol-generating system, the cartridge comprising a susceptor assembly according to a first embodiment of the present disclosure;

FIG. 1B shows a schematic illustration of an alternative cross section of the cartridge of FIG. 1A;

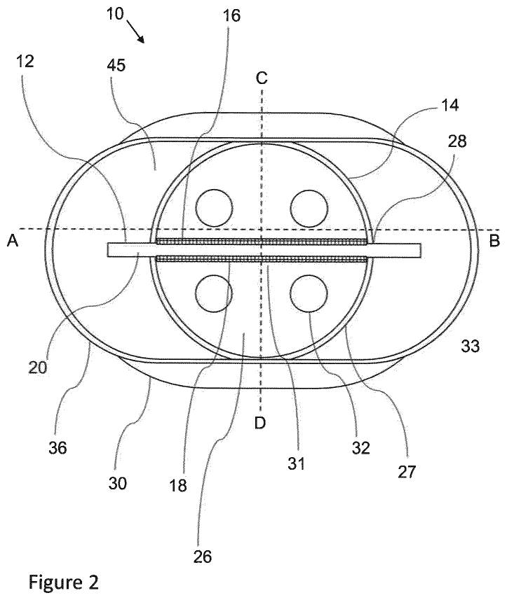

FIG. 2 shows a schematic illustration of a further alternative cross section of the cartridge of FIGS. 1A and 1B;

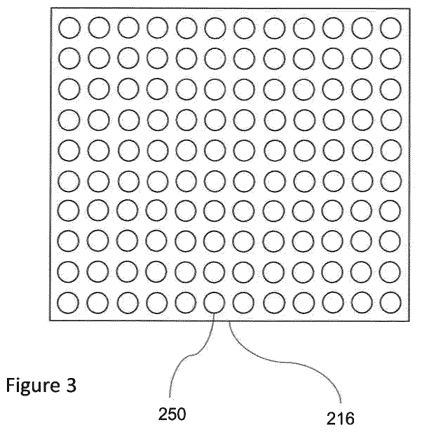

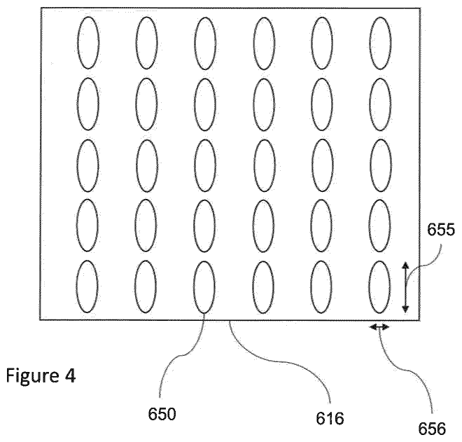

FIG. 3 shows a schematic illustration of a susceptor element according to the present disclosure.

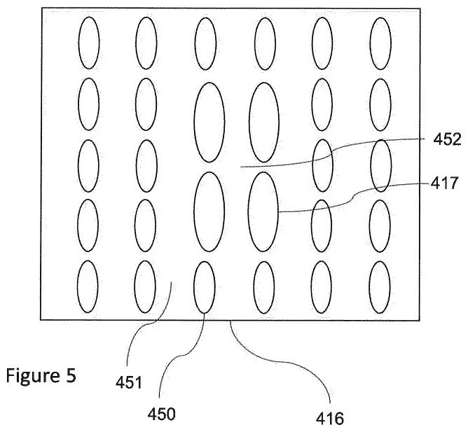

FIG. 4 shows a schematic illustration of a susceptor element according to a first aspect of the present disclosure.

FIG. 5 shows a schematic illustration of a susceptor element according to a second aspect of the present disclosure.

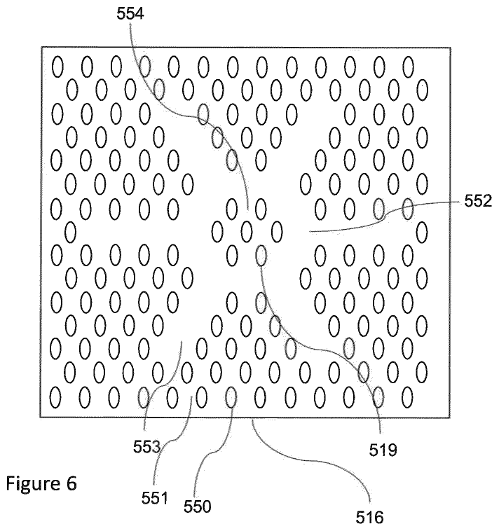

FIG. 6 shows a schematic illustration of a further susceptor element according to the second aspect of the present disclosure.

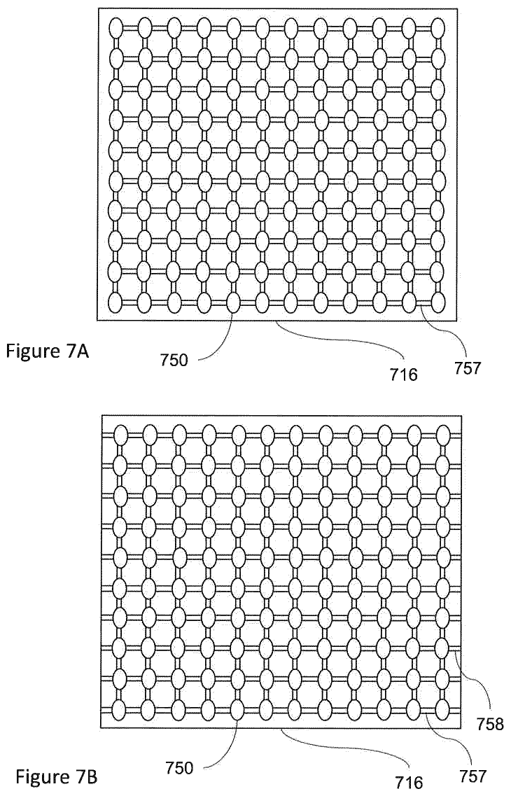

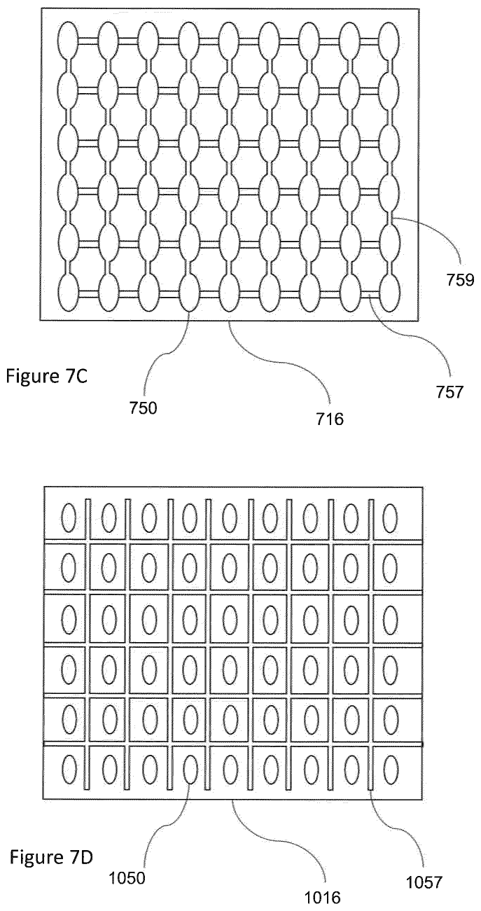

FIGS. 7A, 7B and 7C show schematic illustrations of susceptor elements according to a third aspect of the present disclosure.

FIG. 7D shows a schematic illustration of a further susceptor element according to the present disclosure.

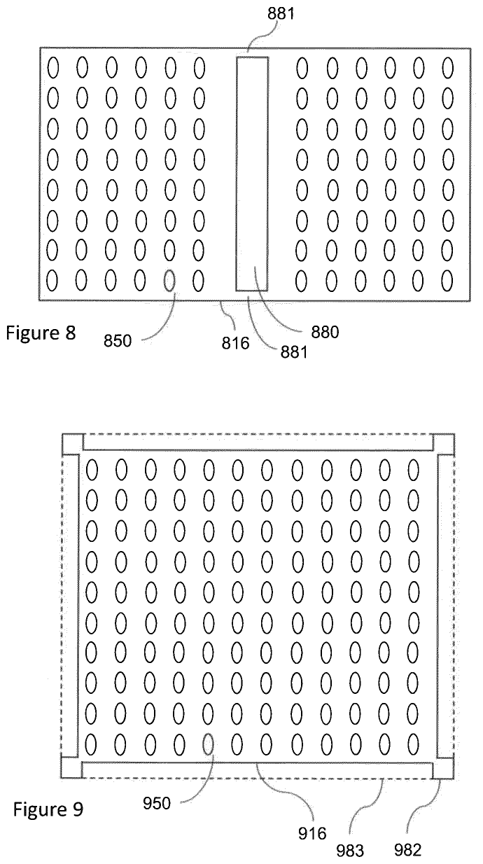

FIG. 8 shows a schematic illustration of a susceptor element according to the present disclosure.

FIG. 9 shows a schematic illustration of a susceptor element according to the present disclosure.

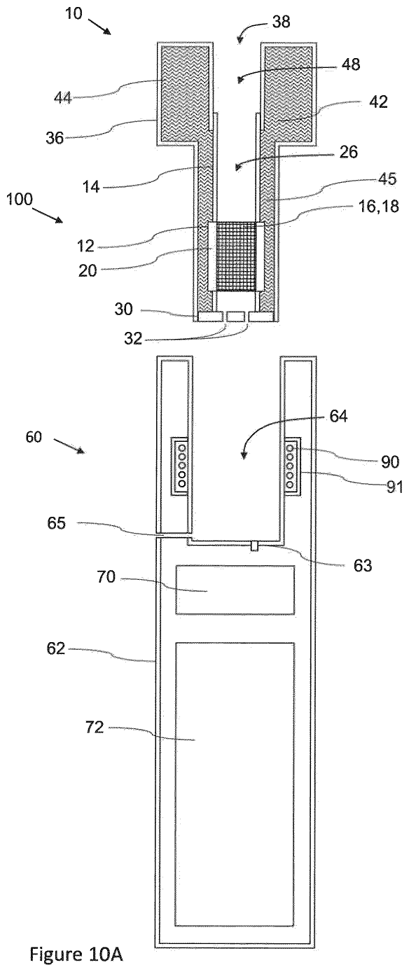

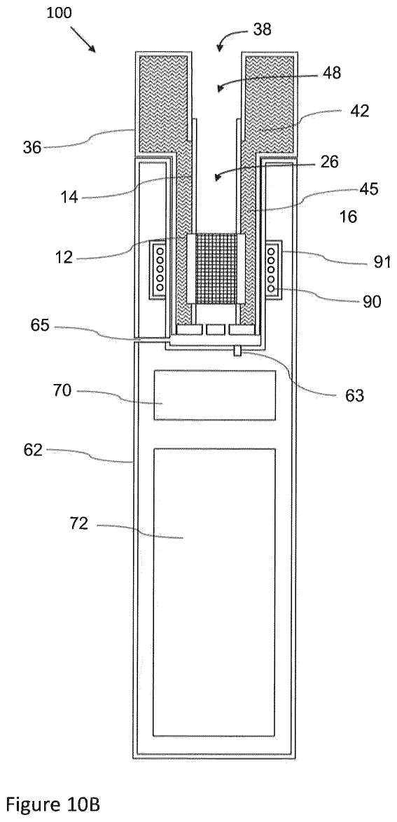

FIG. 10A shows a schematic illustration of a cross section of an aerosol-generating system according to the present disclosure, wherein the cartridge is decoupled from an aerosol generating device;

FIG. 10B shows a schematic illustration of a cross section of an aerosol-generating system according to the present disclosure, wherein the cartridge is coupled to the aerosol generating device;

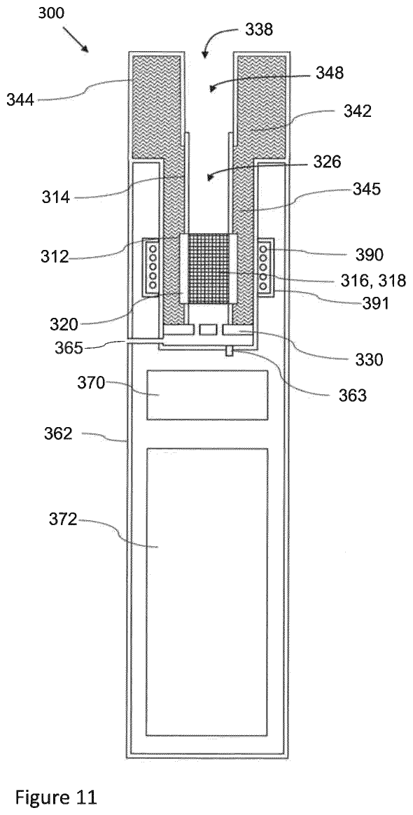

FIG. 11 shows schematic illustration of a cross section of an aerosol-generating device according to the present disclosure.

FIGS. 1A and 1B show schematic illustrations of two cross sections of a cartridge 10 for an aerosol-generating system, the cartridge 10 according to the present disclosure. The two cross sections are taken in two planes perpendicular to one another.

The cartridge 10 comprises a susceptor holder 14, and a susceptor assembly 12 mounted in the susceptor holder 14. The susceptor assembly 12 is planar, and thin, having a thickness dimension that is substantially smaller than a length dimension and a width dimension. The susceptor assembly 12 is shaped in the form of a rectangle, and comprises three layers, a first susceptor element 16, a second susceptor element 18, and a wicking element 20 arranged between the first and second susceptor elements 16, 18. Each of the first susceptor element 16, the second susceptor element 18, and the wicking element 20 generally forms the shape of a rectangle, and each susceptor element has the same length and width dimensions, and the width of the susceptor elements 16, 18 is smaller than the width of the wicking element 20. Wicking element 20 therefore comprises outer, exposed portions of wicking element, each protruding into one of two channels 45. The first and second susceptor elements 16, 18 are substantially identical, and comprise a stainless steel plate, for example a ferritic stainless steel plate. The stainless steel plate comprises a plurality of apertures or holes formed in the plate, each aperture extending from one surface of the plate to the other. The wicking element 20 comprises a porous body of rayon filaments. The wicking element 20 is configured to deliver liquid from the outer, exposed surfaces of the wicking element 20 to the first and second susceptor elements 16, 18.

Each of the first and second susceptor elements 16, 18 is configured to be heatable by penetration with an alternating magnetic field, for vaporising an aerosol-forming substrate. The wicking element 20 contacts the susceptor holder 14, such that the susceptor holder 14 supports the susceptor assembly 12 in position in the cartridge 10.

The susceptor assembly 12 is partially arranged inside the internal passage 26 of the tubular susceptor holder 14, and extends in a plane parallel to a central longitudinal axis of the susceptor holder 14. The first and second susceptor elements 16, 18 are arranged entirely within the internal passage 26 of the susceptor holder 14 and the wicking element extends through openings 28 in the side wall of the susceptor holder 14 into one of two channels 45.

The cartridge 10 has a mouth end, and a connection end, opposite the mouth end. An outer housing 36 defines a mouth end opening 38 at the mouth end of the cartridge 10. The connection end is configured for connection of the cartridge 10 to an aerosol-generating device, as described in detail below. The susceptor assembly 12 and the susceptor holder 14 are located towards the connection end of the cartridge 10.

The outer housing 36 formed from a mouldable plastics material, such as polypropylene. The outer housing 36 defines an internal space in which the susceptor assembly 12 and the susceptor holder 14 are contained.

The external width of the outer housing 36 is greater at the mouth end of the cartridge 10 than at the connection end, which are joined by a shoulder 37. This enables the connection end of the cartridge 10 to be received in a cavity of an aerosol-generating device, with the shoulder 37 locating the cartridge in the correct position in the device. This also enables the mouth end of the cartridge 10 to remain outside of the aerosol-generating device, with the mouth end conforming to the external shape of the aerosol-generating device.

The cartridge 10 further comprises a liquid reservoir 44. The liquid reservoir 44 is defined in the cartridge 10 for holding a liquid aerosol-forming substrate 42.

The liquid reservoir 44 extends from the mouth end of the outer housing 36 to the connection end of the outer housing 36, and comprises an annular space defined by the outer housing 36.

The annular space has an internal passage 48 that extends between the mouth end opening 38, and the open end of the internal passage 26 of the susceptor holder 14.

The liquid reservoir 44 further comprises two channels 45, the two channels 45 being defined between an inner surface of the outer housing 36 and an outer surface of the susceptor holder 14. The two channels 45 extend from the annular space defined by the outer housing 36 at the mouth end of the cartridge 10, to the connection end of the cartridge 10, such that the wicking element extends through the openings 28 in the side wall of the susceptor holder 14 into the two channels 45. The two channels 45 extend from the annular space defined by the outer housing 36 at the mouth end of the cartridge 10 on opposite sides of the internal passage 26 of the susceptor holder 14.

The susceptor holder 14 comprises a base 30 that partially closes one end of the internal passage 26. The base 30 comprises a plurality of air inlets 32 that enable air to be drawn into the internal passage 26 through the partially closed end.

An air passage is formed through the cartridge 10 by the internal passage 26 of the susceptor holder 14, and the internal passage 48 of the liquid reservoir 44. The air passage extends from the air inlets 32 in the base 30 of the susceptor holder 14, through the internal passage 26 of the susceptor holder 14, and through the internal passage 48 of the liquid reservoir 44 to the mouth end opening 38. The air passage enables air to be drawn through the cartridge 10 from the connection end to the mouth end.

FIG. 2 shows a schematic illustration of a further alternative cross section of the cartridge 10 of FIGS. 1A and 1B. The cartridge 10 is viewed perpendicular to the views shown in FIGS. 1A and 1B, such that the cross section shown in FIG. 1A is indicated by the dashed line AB, and the cross section shown in FIG. 1B is indicated by the dashed line CD.

The cartridge 10 comprises a susceptor holder 14. The susceptor holder 14 comprises a tubular body formed from a mouldable plastic material, such as polypropylene. The tubular body of the susceptor holder 14 comprises a side wall 27 defining an internal passage 26, having open ends. A pair of openings 28 extend through the side wall 27, at opposite sides of the tubular susceptor holder 14. The openings 28 are arranged centrally along the length of the susceptor holder 14.

The openings 28 in the side wall of the susceptor holder 14 are sized to accommodate the susceptor assembly 12 with a friction fit, such that the susceptor assembly is secured in the susceptor holder 14. The friction fit between the susceptor assembly 12 and the susceptor holder 14 results in the mounting regions 22 directly contacting the susceptor holder 14 at the openings 28. The susceptor assembly 12 and the susceptor holder 14 are secured together such that movement of the susceptor holder 14 also moves the susceptor assembly 12.

It will be appreciated that the susceptor assembly 12 and the susceptor holder 14 may be secured together by other means. For example, in some embodiments the susceptor assembly 12 is secured to the susceptor holder 14 by an adhesive at the mounting regions 22 of the susceptor assembly 12, such that the mounting regions 22 indirectly contact the susceptor holder 14.

The two channels 45 are positioned on opposite sides of the internal passage 26, and in use the two channels 45 supply liquid aerosol-forming substrate to the susceptor assembly 12. The wicking element 20 extends out of the internal passage 26 into both of the channels 45 via the openings 28. The channels 45 are shown empty in FIG. 2, but can be understood to be filled with liquid aerosol-forming substrate prior to use.

The cartridge 10 is viewed in FIG. 2 from the mouth end to the connection end. The plurality of air inlets 32 in the base 30 can therefore be seen in FIG. 2.

The cross section of the susceptor assembly 12 can be more clearly seen in FIG. 2, with the wicking element 20 arranged between the first and second susceptor elements 16, 18. It can be understood however that the first and second susceptor elements 16, 18 may instead be a singular susceptor element wrapped around the wicking element 20, the singular susceptor element comprising a first portion on a first side of the susceptor assembly 12 and a second portion on a second side of the susceptor assembly 12.

Although in FIGS. 1A, 1B and 2, the susceptor assembly 12 is shown as substantially planar, it can be understood that the susceptor assembly 12 may take any other suitable shape or form.

FIG. 3 shows a schematic illustration of the susceptor element 216 according to the present disclosure. The susceptor element 216 may comprise the first susceptor element 16 or second susceptor element 18 as in FIGS. 1A, 1B and 2. The susceptor element 216 is in the form of a non-woven sheet. For example, the susceptor element 216 is in the form of a sheet of ferritic stainless steel. The susceptor element 216 comprises a regular array of apertures 250. The schematic illustration of the susceptor element 216 (and of any following illustrated susceptor elements) is schematic, and the apertures 250 may be much smaller or greater in number, or much larger or lower in number, relative to the dimensions of the non-woven sheet. The apertures 250 in this example are shown as circular apertures. However, any shape aperture may be used. For example, square, triangular, or rectangular apertures. The regular array of apertures 250 extends across the entire extent of the non-woven sheet. In the embodiment shown, the regular array of apertures 250 may be described as a square array, such that each aperture has four nearest neighbours unless the aperture is located at the edge of the sheet. Other types of arrays may be used. For example, a hexagonal array, wherein each aperture has six nearest neighbours, unless the aperture is located at the edge of the sheet. The sheet is between 25 and 100 micrometres in thickness. Each aperture 250 is between 20 micrometres and 510 micrometres in diameter. Each aperture is formed by either laser cutting, chemical etching, stamping or wire electrical discharge. The susceptor element comprising the plurality of apertures may be formed by additive manufacturing such as laser sintering or laser melting.

FIG. 4 shows a schematic illustration of a susceptor element 616 according to a first aspect of the present disclosure. The susceptor element 616 of FIG. 4 is similar to the susceptor element 216 as shown in FIG. 3, so is described with respect to its differences only. The susceptor element 616 comprises a plurality of apertures 650, each aperture oval, or elongate, in shape. In other words, each aperture 650 extends by a first distance 655 in a first direction and each aperture extends by a second distance 656 in a second direction, and the first distance 655 is greater than the second distance 656. Both the first and second directions are in the plane of the susceptor element 616, such that the first and second directions are both parallel to the first and second surfaces of the susceptor element 616. In this example, the first distance 655 is between 1.5 and 10 times the second distance 656. The first distance 655 is preferably about 5 times the second distance 656. Although the apertures are shown to be oval in shape, the apertures 650 may instead be rectangular in shape, for example. The plurality of apertures 650 are arranged in an array, such as a rectangular array as shown in FIG. 4, with each aperture 650 having two nearest neighbours in the first direction. Each aperture 650 is spaced in the first direction by a first spacing distance between 0.05 and 1 times the first distance 655. Each aperture 650 is spaced in the second direction by a second spacing distance between 0.2 and 5 times the second distance 656.

The susceptor element 616 in FIG. 4 is configured to be arranged within the cartridge 10 of FIGS. 1A, 1B and 2 such that the first direction is parallel to the axial direction of the internal airflow passage 26. When the cartridge 10 is received in the aerosol generating system (see FIGS. 10A and 10B below) the first direction is parallel to the direction of varying magnetic field. It has been found that extension of the apertures 650 in the second direction (perpendicular to the direction of the varying magnetic field) does not contribute significantly to power and heat generation by induction. Such an arrangement of elongated apertures in the first direction improves the inductive heating response of the susceptor when exposed to an alternating magnetic field in the first direction. The improved inductive heating response may then result in more preferable aerosol characteristics of the aerosol generated by the aerosol-generating system. Therefore, it is beneficial to dispose the susceptor element 616 such that the elongated direction of the apertures 650 are aligned with the direction of the varying magnetic field.

FIG. 5 shows a schematic illustration of a susceptor element 416 according to a second aspect of the present disclosure. The susceptor element 416 of FIG. 4 is similar to the susceptor element 616 as shown in FIG. 4, so is described with respect to its differences only. The susceptor element 416 comprises a first region 451. The first region 451 comprises a first square array of first apertures 450. The apertures 450 in the first region 451 are identical to each other. The susceptor element 416 further comprises a second region 452. The second region 452 comprises a second square array of second apertures 417. The apertures 417 in the second region 452 are identical to each other. The apertures in the second region 452 are larger than the apertures in the first region 451, such that the apertures in the second region 452 have a greater diameter than the apertures in the first region 451. The apertures 417 in the second region 452 have a lower density than the apertures 450 in the first region 451, such that there are fewer apertures per unit area in the second region 452 than in the first region 451. The first region 451 surrounds the second region 452. The second region 452 is located at the centre of the susceptor element, such that the second region 452 is located at least near the axial centre of the air flow passage when the susceptor element 416 is positioned within the susceptor holder, as in FIGS. 1A, 1B and 2. When the susceptor element 416 is positioned within the susceptor holder of the cartridge, the cartridge is positioned within an aerosol-generating device, and the susceptor element is heated by an inductive heating arrangement (see FIGS. 10A and 10B), the first region 451 is heated more than the second region 452, such that more heat is generated in the first region 451 than in the second region 452. Consequently, the risk of the wicking element being scorched by excess heat generation near the centre of the susceptor element is reduced.

FIG. 6 shows a schematic illustration of a further susceptor element according to the second aspect of the present disclosure. The susceptor element 516 of FIG. 6 is similar to the susceptor element 416 as shown in FIG. 5, so is described with respect to its differences only. The first region 551 comprises a first hexagonal array of apertures 550. The apertures 550 in the first region 551 are identical to each other. The susceptor element 516 further comprises a second region 552. The second region 552 comprises a shape comprising no apertures. In other words, the second region 552 is comprised of an unperforated non-woven sheet of stainless steel. The apertures in the second region 552 have a lower density than the apertures 550 in the first region 551, as there no apertures per unit area in the second region 552. The first region 551 surrounds the second region 552. The second region 552 is located at the centre of the susceptor element 516, such that the second region 552 is located at least near the axial centre of the air flow passage when the susceptor element 516 is positioned within the susceptor holder, as in FIGS. 1A, 1B and 2. The susceptor element 516 further comprises a third region 554. The second region 552 surrounds the third region 554. The third region 554 comprises a hexagonal array of third apertures 519. The hexagonal array of third apertures 519 is identical in arrangement to the hexagonal array of first apertures 550. The apertures 519 in the third region 554 are identical to each other. The apertures 519 in the third region 554 are identical to the apertures 550 in the first region 551, such that the apertures in the third region have an identical shape than the apertures 550 in the first region 551.

The second region 552 comprises six radial portions 553. Each radial portion 553 extends from a centre of the second region 552, near the centre of the susceptor element 516, towards the periphery of the susceptor element 516. In this example, the radial portions are therefore distributed in a configuration such that heat generated near the centre of the susceptor element 516 is efficiently transported from the central area (the hottest area) of the susceptor element 516, along predefined paths through where there are no perforations to neighbouring regions of apertures, namely the first region of apertures 551. In other words, the radial portions 553 constitute heat sink channels through which the heat is dissipated towards peripheral areas of the susceptor element 516. As a result, heat is dissipated quickly from the centre of the susceptor element 516, which may avoid wick scorch, or overheating of the centre of the susceptor element 516.

FIGS. 7A and 7B show schematic illustrations of a susceptor element according to a third aspect of the present disclosure. The susceptor elements 716 of FIGS. 7A and 7B are similar to the susceptor element 616 as shown in FIG. 4, so is described with respect to its differences only. In FIG. 7A, the susceptor element 716 further comprises a plurality of channels 757. Each channel 757 of the plurality of channels 757 is extends between two nearest neighbour apertures 750. Each channel 757 extends from a first surface of the non-woven sheet approximately half way through the non-woven sheet towards a second surface of the non-woven sheet. In other words, the channels 757 in FIG. 7A do not extend through the non-woven sheet from the first surface to the second surface.

The channels 757 are configured to exert a capillary force on the liquid aerosol-forming substrate, such that the channels 757 assist in transporting the liquid aerosol-forming substrate across the first surface of the susceptor element 716. The channels 757 are capillary channels. The capillary channels have dimensions such that a capillary force is exerted on the liquid aerosol-forming substrate within the channels. The optimum dimensions of the capillary channels depend on factors such as the viscosity of the liquid aerosol-forming substrate and the material used for the susceptor element. The susceptor element 716 may be arranged with an identical susceptor element 716 as shown in FIGS. 1A, 1B and 2, wherein the wicking element 20 is sandwiched between two identical susceptor elements 716. The two identical susceptor elements 716 may be oriented such that the first surfaces contact the wicking element 20. In other words, the channels 757 are located on the surfaces of the susceptor elements 716 which contact the wicking element 20. It is contemplated however for the two identical susceptor elements 716 to be oriented such that the second surfaces contact the wicking element 20. In other words, the channels 757 are located on the surfaces of the susceptor elements 716 which do not contact the wicking element 20.

It is also contemplated that arrangement with no wicking element 20 may be used. In FIG. 7B, the susceptor element 716 further comprises a plurality of peripheral channels 758. Each peripheral channel 758 extends between an edge of the non-woven sheet and one aperture 750 nearest to the edge of the non-woven sheet. Each peripheral channel 758 extends from a first surface of the non-woven sheet approximately halfway through the non-woven sheet towards a second surface of the non-woven sheet. In other words, the peripheral channels 758 in FIG. 7B do not extend through the non-woven sheet from the first surface to the second surface. Each peripheral channel is similar in form and function to each channel of the plurality of channels 757, in that each peripheral channel 758 assists in transporting the liquid aerosol-forming substrate across the first surface of the susceptor element 716. However, in arrangements with no wicking element 20, the susceptor element 716 extends into the two channels 45. The peripheral channels 758 therefore have the function of exerting a capillary force on the liquid aerosol-forming substrate within the two channels 45, to draw the liquid across the first surface of the susceptor element 716 and into the internal airflow passage 26 where the liquid aerosol-forming substrate may be vapourised. Each channel and peripheral channel is formed by etching, for example chemical etching.

FIG. 7C shows a schematic illustration of a further susceptor element according to the third aspect of the present disclosure. The susceptor element 716 of FIG. 7C is similar to the susceptor element 716 as shown in FIG. 7A, so is described with respect to its differences only. In FIG. 7C, the susceptor element 716 comprises a plurality of vertical channels 759. Each vertical channel 759 extends from the first surface of the non-woven sheet to the second surface of the non-woven sheet. In other words, the vertical channels 759 in FIG. 7C extend completely through the non-woven sheet from the first surface to the second surface. The horizontal channels 757, as in FIG. 7A, extend only partially from the first surface to the second surface of the susceptor element. All portions of the susceptor element are therefore connected by at least some material.

FIG. 7D shows a schematic illustration of a further susceptor element according to the present disclosure. The susceptor element 1016 of FIG. 7D is similar to the susceptor element 716 as shown in FIG. 7A, so is described with respect to its differences only. The susceptor element comprises a plurality of channels 1057. Each channel of the plurality of channels does not extend between or contact any apertures 1050 of the plurality of apertures. Each channel of the plurality of channels extends either vertically or horizontally over the susceptor element to form a grid pattern. Each aperture of the plurality of apertures is positioned in the square or rectangular portions of susceptor element formed by the grid of channels. The horizontal channels of the plurality of channels extend between two peripheral edges of the susceptor element. Advantageously, this arrangement of channels facilitates liquid aerosol-forming substrate transportation from the peripheral edge of the susceptor element, which may be in contact with a reservoir of liquid aerosol-forming substrate as in FIGS. 1A, 1B and 2, towards the centre of the susceptor element. Although the susceptor is described as comprising a plurality of channels, the plurality of channels all overlap with one another to form an interconnected network of channels.

FIG. 8 shows a schematic illustration of a susceptor element according to the present disclosure. The susceptor element 816 of FIG. 8 is similar to the susceptor element 616 as shown in FIG. 4, so is described with respect to its differences only. The susceptor element 816 of FIG. 8 is configured to be folded around the wicking element 20 in FIGS. 1A, 1B and 2. In order to facilitate this folding, an elongated aperture 880 is positioned in the centre of the susceptor element 816. The elongated aperture 880 divides the susceptor element into two approximately equal portions, each of the equal portion comprising a plurality of apertures 850 arranged in a square array as described with respect to FIG. 3. The elongated aperture 880 extends the majority of the distance across the susceptor element 816, leaving two connecting portions 881 between the two approximately equal portions of susceptor element 816. When the susceptor element 816 is folded around the wicking element 20, the connecting portions 881 may therefore easily deform, allowing for ease of manufacturing. The elongated aperture 880 is formed by either laser cutting, chemical etching, stamping or wire electrical discharge.

FIG. 9 shows a schematic illustration of a susceptor element according to the present disclosure. The susceptor element 916 of FIG. 9 is similar to the susceptor element 616 as shown in FIG. 4, so is described with respect to its differences only. The susceptor element 916 of FIG. 9 further comprises four outward protrusions 982 positioned at the four corners of the peripheral edge of the non-woven sheet of the susceptor element 916. The outward protrusions 982 are configured to engage with corresponding slots in the susceptor holder 14 of the cartridge. The susceptor element 916 may therefore be secured to the susceptor holder 14 for increased security of the susceptor assembly relative to the susceptor holder 14. The outward protrusions 982 occupy between 2 percent and 10 percent of the peripheral edge of the susceptor element 916 in order to minimise heat transfer from the susceptor element 916 to the susceptor holder 14. Such an arrangement would not be possible with a woven susceptor element due to fraying of the woven filaments. The outward protrusions 982 are formed by removing excess non-woven sheet. The excess non-woven sheet is removed by either laser cutting, chemical etching, stamping or wire electrical discharge. The outline of the removed non-woven sheet is shown in the dashed line 983.

FIG. 10A shows a schematic illustration of a cross section of an aerosol-generating system 100 according to the present disclosure, wherein the cartridge 10 is decoupled from an aerosol generating device 60.

The cartridge 10 is identical to that presented in FIGS. 1A, 1B and 2, and their corresponding descriptions.

The aerosol-generating device 60 comprises a generally cylindrical device outer housing 62 having a connection end and a distal end opposite the connection end. A cavity 64 for receiving the connection end of the cartridge is located at the connection end of the device 60, and an air inlet 65 is provided through the device outer housing 62 at the base of the cavity 64 to enable ambient air to be drawn into the cavity 64.

The device 60 further comprises an inductive heating arrangement arranged within the device outer housing 62. The inductive heating arrangement includes an inductor coil 90, control circuitry 70 and a power supply 72. The power supply 72 comprises a rechargeable lithium ion battery, that is rechargeable via an electrical connector (not shown) at the distal end of the device. The control circuitry 70 is connected to the power supply 72, and to the inductor coil 90, such that the control circuitry 70 controls the supply of power to the inductor coil 90. The control circuitry 70 is configured to supply an alternating current to the inductor coil 90.

The singular inductor coil 90 is positioned around the susceptor assembly 12 when the cartridge 10 is received in the cavity 64. The inductor coil 90 has a size and a shape matching the size and shape of the heating regions of the susceptor elements. The inductor coil 90 is made with a copper wire having a round circular section, and is arranged on a coil former element (not shown). The inductor coil 90 is a helical coil, and has a circular cross section when viewed parallel to the longitudinal axis of the aerosol-generating device.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to attenuate the alternating magnetic field outside of the aerosol-generating system. This may reduce interference between the alternating magnetic field and other nearby electronic devices and reduce the risk of the alternating magnetic field inductively heating nearby objects outside of the aerosol-generating system.

FIG. 10B shows a schematic illustration of a cross section of the aerosol-generating system 100 of FIG. 10A, but wherein the cartridge 10 is coupled to the aerosol generating device 60.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10, as shown by the arrows in FIG. 7a. The ambient air flows through the cartridge 10 from the base 30 to the mouth end opening 38, through the air passage, and over the susceptor assembly 12.

The control circuitry 70 controls the supply of electrical power from the power supply 72 to the inductor coil 90 when the system is activated.

The control circuitry 72 includes an airflow sensor 63. The airflow sensor 63 is in fluid communication with the passage of ambient air which is drawn through the system by the user. The control circuitry 72 supplies electrical power to the inductor coil 66 when user puffs on the cartridge 10 are detected by the airflow sensor 63.

When the system is activated, an alternating current is established in the inductor coil 90, which generates alternating magnetic fields in the cavity 64 that penetrate the susceptor assembly 12, causing the susceptor elements to heat. Liquid aerosol-forming substrate in the channels 45 is drawn into the susceptor assembly 12 through the wicking element 20 to the susceptor elements. The liquid aerosol-forming substrate 42 at the susceptor elements is heated, and volatile compounds from the heated aerosol-forming substrate are released into the air passage of the cartridge 10, which cool to form an aerosol. The aerosol is entrained in the air being drawn through the air passage of the cartridge 10 and is drawn out of the cartridge 10 at the mouth end opening 38 for inhalation by the user.

FIG. 11 shows schematic illustration of a cross section of an aerosol-generating device 300 according to the present disclosure. The aerosol-generating device 300 according to the present disclosure comprises the majority of the components of the aerosol-generating system 100 as shown in FIGS. 10A and 10B, and operates in a similar manner. Therefore, unless otherwise stated, the description of any element of the aerosol-generating device 300 is identical to description of the corresponding element of the cartridge in FIGS. 1A, 1B and 2 or the aerosol-generating system in FIGS. 10A and 10B.

One difference is that the aerosol-generating device 300 according to the present disclosure does not comprise a separate cartridge, and most of the features of the cartridge 10 according to FIGS. 1A, 1B and 2 are instead incorporated into the aerosol generating device 300.

As described previously, the aerosol-generating device 300 comprises a generally cylindrical device outer housing 362 having a mouth end and a distal end opposite the mouth end. An air inlet 365 is provided through the device outer housing 362 into the device 300

The device 300 further comprises an inductive heating arrangement arranged within the device outer housing 362. The inductive heating arrangement includes an inductor coil 390, control circuitry 370 and a power supply 372. The power supply 372 comprises a rechargeable lithium ion battery, that is rechargeable via an electrical connector (not shown) at the distal end of the device. The control circuitry 370 is connected to the power supply 372, and to the inductor coil 390, such that the control circuitry 370 controls the supply of power to the inductor coil 390. The control circuitry 370 is configured to supply an alternating current to the inductor coil 390.

The singular inductor coil 390 is positioned around the susceptor assembly 312. The inductor coil 390 has a size and a shape matching the size and shape of the heating regions of the susceptor elements. The inductor coil 390 is made with a copper wire having a round circular section, and is arranged on a coil former element (not shown). The inductor coil 390 is a helical coil, and has a circular cross section when viewed parallel to the longitudinal axis of the aerosol-generating device.

The inductor coil 390 is configured such that when the alternating current is supplied to the inductor coil, the inductor coil generates an alternating magnetic field in the region of the susceptor assembly 312.

The inductive heating arrangement further includes a flux concentrator element 91, as described previously.

The susceptor assembly 312 and susceptor holder 314 is identical to the susceptor assembly 12 and susceptor holder 314 presented in FIGS. 1A to 2. As described previously, the susceptor assembly 312 is planar, and thin, having a thickness dimension that is substantially smaller than a length dimension and a width dimension. The susceptor assembly 312 is shaped in the form of a rectangle, and comprises three layers, a first susceptor element 316, a second susceptor element 318, and a wicking element 320 arranged between the first and second susceptor elements 316, 318. Each of the first susceptor element 316, the second susceptor element 318, and the wicking element 320 generally forms the shape of a rectangle, and each susceptor element has the same length and width dimensions, and the width of the susceptor elements 316, 318 is smaller than the width of the wicking element 320. Wicking element 320 therefore comprises outer, exposed portions of wicking element, each protruding into one of two channels 345. The first and second susceptor elements 316, 318 are substantially identical, and comprise a stainless steel plate with a plurality of apertures formed therethrough.

As described previously, the susceptor holder 314 also comprises a base 330 that partially closes one end of the internal passage 326. The base 330 comprises a plurality of air inlets that enable air to be drawn into the internal passage 326 through the partially closed end. As described previously, the susceptor holder 314 comprises a tubular body formed from a mouldable plastic material, such as polypropylene. The tubular body of the susceptor holder 314 comprises a side wall defining an internal passage 326, having open ends. The skilled person would understand however that as the device 300 does not comprise a removable cartridge, that the susceptor holder may instead be integrally formed with the device 300, in particular with the device outer housing 362.

Similarly, the aerosol-generating device 300 further comprises a liquid reservoir 344. The liquid reservoir 344 is defined by the device outer housing 362 for holding a liquid aerosol-forming substrate 342. The liquid reservoir 344 extends from the mouth end of the outer housing 362 to the connection end of the device outer housing 362, and comprises an annular space defined by the device outer housing 362. The annular space has an internal passage 348 that extends between the mouth end opening 338, and the open end of the internal passage 326 of the susceptor holder 314. The liquid reservoir 344 further comprises two channels 345, the two channels 345 being defined between an outer surface of the susceptor holder 314, and an internal surface of the device. The two channels 345 extend from the annular space defined by the device outer housing 362 at the mouth end of the device 300, to the connection end of the device 300, such that the wicking element 320 extends through the openings in the side wall of the susceptor holder 314 into the two channels 345. The two channels 345 extend from the annular space defined by the device outer housing 362 at the mouth end of the device 300 on opposite sides of the internal passage 326 of the susceptor holder 314.

Similarly, an air passage is formed through the device 300 by the internal passage 326 of the susceptor holder 314, and the internal passage 348 of the liquid reservoir 344. The air passage extends from the air inlets in the base 330 of the susceptor holder 314, through the internal passage 326 of the susceptor holder 314, and through the internal passage 348 of the liquid reservoir 344 to the mouth end opening 338. The air passage enables air to be drawn through the device 300 from the air inlet 365 to the mouth end opening 338.

Similarly, the control circuitry 372 includes an airflow sensor 363. The airflow sensor 363 is in fluid communication with the passage of ambient air which is drawn through the device 300 by the user. The control circuitry 372 supplies electrical power to the susceptor elements 316, 318 when user puffs on the device 300 are detected by the airflow sensor 363.

When the device is activated, an alternating current is established in the inductor coil 390 which causes the susceptor elements 316, 318 to inductively heat. Liquid aerosol-forming substrate 342 in the channels 345 is drawn into the susceptor assembly 312 through the wicking element 320 to the susceptor elements 316, 318. The liquid aerosol-forming substrate 342 at the susceptor elements is heated, and volatile compounds from the heated aerosol-forming substrate are released into the air passage 326, 348 of the device 300, which cool to form an aerosol. The aerosol is entrained in the air being drawn through the air passage 326, 348 of the device 300, and is drawn out of the device 300 at the mouth end opening 338 for inhalation by the user.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein. Also, for the purpose of the present description, the term “identical” refers to features which are designed to be identical within the general standard manufacturing tolerances of the features in question.

1.-15. (canceled)

16. A heating assembly for an aerosol-generating system, the heating assembly comprising a susceptor assembly, the susceptor assembly comprising:
at least one non-woven susceptor element in a form of a sheet and comprising a plurality of apertures, each aperture extending from a first surface of the sheet to a second surface of the sheet; and
a wicking element coupled to the at least one non-woven susceptor element, the wicking element being configured to transport aerosol-forming liquid across a surface of the at least one non-woven susceptor element,
wherein each aperture of the plurality of apertures extends in a first direction parallel to at least one of the first surface and second surface of the at least one non-woven susceptor element,
wherein each aperture of the plurality of apertures extends in a second direction parallel to at least one of the first surface and second surface of the at least one non-woven susceptor element and perpendicular to the first direction,
wherein each aperture of the plurality of apertures extends a greater distance in the first direction than in the second direction,
wherein the at least one non-woven susceptor element is planar and defines a first plane, such that the first direction and second direction are within the first plane,
wherein the heating assembly further comprises an inductor that at least in part surrounds the at least one non-woven susceptor element, and
wherein the inductor is configured to generate a magnetic field that varies in a direction parallel to the first direction.

17. The heating assembly according to claim 16,
wherein each aperture of the plurality of apertures extends by a first distance in the first direction and each aperture of the plurality of apertures extends by a second distance in the second direction, and
wherein the first distance is between 1.5 and 10 times that of the second distance.

18. The heating assembly according to claim 16, wherein the plurality of apertures form a regular array of apertures in the at least one non-woven susceptor element.

19. The heating assembly according to claim 18, wherein the plurality of apertures are spaced in the second direction by a second spacing distance between 0.2 times the second distance and 5 times the second distance.

20. The heating assembly according to claim 16, wherein the wicking element comprises first and second planar surfaces, the first and the second planar surfaces defining opposite, outward-facing surfaces of the wicking element.

21. The heating assembly according to claim 20,
wherein the at least one non-woven susceptor element comprises a first planar susceptor element and a second planar susceptor element, and
wherein the susceptor assembly is arranged such that the first surface of the wicking element contacts the first planar susceptor element and the second surface of the wicking element contacts the second planar susceptor element.

22. The heating assembly according to claim 20,
wherein the at least one non-woven susceptor element is folded around the wicking element, such that the first surface of the wicking element contacts a first portion of the at least one non-woven susceptor element and the second surface of the wicking element contacts a second portion of the at least one non-woven susceptor element, and
wherein the first portion is substantially parallel to the second portion.

23. The heating assembly according to claim 22,
wherein the at least one non-woven susceptor element further comprises a folded portion connected between the first portion and the second portion,
wherein the folded portion comprises an elongated aperture, and
wherein the elongated aperture extends in a direction parallel to at least one of the first surface and the second surface of the wicking element.

24. The heating assembly according to claim 23,
wherein the folded portion further comprises at least one connecting portion between the first portion of the at least one non-woven susceptor element and the second portion of the at least one non-woven susceptor element, and
wherein the first portion of the at least one non-woven susceptor element and the second portion of the at least one non-woven susceptor element and the at least one connecting portion are integrally formed.

25. The heating assembly according to claim 16, wherein the at least one non-woven susceptor element comprises at least one outward protrusion, the at least one outward protrusion positioned on a peripheral edge of the at least one non-woven susceptor element.

26. The heating assembly according to claim 25,
wherein the at least one outward protrusion comprises four outward protrusions positioned at the four corners of the peripheral edge of the non-woven sheet of the at least one non-woven susceptor element, and
wherein the outward protrusions are configured to engage a susceptor holder component of a cartridge.

27. The heating assembly according to claim 16,
wherein the at least one non-woven susceptor element comprises a first region, the first region comprising a first configuration of apertures of the plurality of apertures,
wherein the at least one non-woven susceptor element further comprises a second region, the second region comprising a second configuration of apertures of the plurality of apertures, and
wherein the second configuration of apertures is different from the first configuration of apertures.

28. The heating assembly according to claim 27, wherein the second configuration of apertures is different from the first configuration of apertures such that a temperature of the first region increases more than a temperature of the second region when the first region is exposed to an identical alternating magnetic field as the second region, and when the alternating magnetic field is uniform across the first region and the second region.

29. An aerosol-generating device, comprising:
the heating assembly according to claim 16;
an air inlet and an air outlet;
an internally positioned airflow passage extending between the air inlet and the air outlet;
a reservoir for liquid aerosol-forming substrate, wherein the reservoir is in fluid communication with the wicking element of the susceptor assembly; and
a battery configured to supply an alternating current to the inductor to generate a magnetic field,
wherein the at least one non-woven susceptor element is positioned in the airflow passage, such that the at least one non-woven susceptor element is at least partially within the magnetic field generated by the inductor.

30. An aerosol-generating system, comprising:
an aerosol-generating device and a cartridge, the cartridge configured to be couplable to the aerosol-generating device; and
the heating assembly according to claim 16,
wherein the cartridge comprises the susceptor assembly and the aerosol-generating device comprises the inductor,
wherein the cartridge further comprises:
an air inlet and an air outlet,
an internally positioned cartridge airflow passage extending between the air inlet and the air outlet, and
a reservoir for liquid aerosol-forming substrate,
wherein the at least one non-woven susceptor element is positioned in the cartridge airflow passage, and
wherein the reservoir is in fluid communication with the wicking element of the susceptor assembly,
wherein the aerosol-generating device further comprises:
a device airflow inlet and a device airflow outlet,
a device airflow passage extending between the device airflow inlet and the device airflow outlet, and
a battery configured to supply an alternating current to the inductor to generate a magnetic field, such that the at least one non-woven susceptor element is at least partially within the magnetic field generated by the inductor when the cartridge is coupled to the aerosol-generating device,
wherein the inductor at least in part surrounds the at least one non-woven susceptor element when the cartridge is coupled to the aerosol-generating device, and
wherein the magnetic field generated by the inductor varies in a direction parallel to the first direction.
